(19) United States
(12) Patent Application Publication
(10) Pub. No.: US 2022/0329348 A1
(43) Pub. Date: Oct. 13, 2022

(54) DATA PROCESSING METHOD AND DEVICE

(71) Applicant: Huawei Technologies Co., Ltd., Shenzhen (CN)

(72) Inventors: Jiahui LI, Shenzhen (CN); Min YAN, Shenzhen (CN); Mengyao MA, Shenzhen (CN); Wei LIN, Shenzhen (CN)

(21) Appl. No.: 17/572,302

(22) Filed: Jan. 10, 2022

Related U.S. Application Data
(63) Continuation of application No. PCT/CN2020/096388, filed on Jun. 16, 2020.

(30) Foreign Application Priority Data
Jul. 10, 2019 (CN) 201910622112.3

(51) Int. Cl. H04L 1/00

(52) U.S. Cl. CPC H04L 1/0009; H04L 1/0033; H04L 1/0036

(57) ABSTRACT

In a data processing method, a transmit end may send, to a receive end, coding information of N layers of first bit sequences and second information that does not include some or all bits in the N layers of first bit sequences, and the receive end may process the coding information and the second information, to obtain the N layers of first bit sequences. Because the transmit end sends the coding information to the receive end, information sent by the transmit end may not include some or all bits in the N layers of first bit sequences.

### CROSS-REFERENCE TO RELATED APPLICATIONS

This application is a continuation of International Application No. PCT/CN2020/096388, filed on Jun. 16, 2020, which claims priority to Chinese Patent Application No. 201910622112.3, filed on Jul. 10, 2019. The disclosures of the aforementioned applications are hereby incorporated by reference in their entireties.

### TECHNICAL FIELD

This application relates to the field of communications technologies, and in particular, to a data processing method and apparatus.

### BACKGROUND

Multimedia communication is a new communications mode in which a plurality of types of media data such as a voice, data, an image, and a video can be simultaneously provided in one call process. As an important part of multimedia data, the video brings a new visual experience to a user. In the next few years, a video service has a wider development prospect, and accordingly, a video data coding and transmission technology also becomes a research hotspot in the current multimedia communications field.

Because wireless channel bandwidth is limited, how to lower a requirement of the video data for bandwidth and improve coding efficiency is an urgent problem to be resolved in video data transmission.

### SUMMARY

This application provides a data processing method and apparatus, to improve coding efficiency.

This application provides the following technical solutions:

According to a first aspect, a data processing method is provided, including: A transmit end layers original information, to obtain N layers of first bit sequences, where the original information is at least one bit sequence or at least one integer, and N is an integer greater than 1; the transmit end performs first processing on the N layers of first bit sequences, to obtain first information, where the first information does not include all bits in the N layers of first bit sequences or the first information includes some bits in the N layers of first bit sequences; the transmit end performs second processing on the first information, to obtain second information; the transmit end performs channel coding and constellation modulation on coding information of proportion information of 0 or 1 in each of the N layers of first bit sequences, to obtain third information; and the transmit end sends the second information and the third information to a receive end. In the method provided in the first aspect, the transmit end may send, to the receive end, coding information of the N layers of first bit sequences and second information that does not include some or all bits in the N layers of first bit sequences, and the receive end may process the coding information and the second information, to obtain the N layers of first bit sequences. Because the transmit end sends the coding information to the receive end, information sent by the transmit end may not include some or all bits in the N layers of first bit sequences. Therefore, a requirement of data for bandwidth is lowered, and data coding efficiency is improved.

In a possible implementation, that a transmit end layers original information, to obtain N layers of first bit sequences includes: The transmit end layers the original information in descending order or ascending order of importance of information in the original information, to obtain the N layers of first bit sequences.

In a possible implementation, the first processing includes channel coding and bit clipping, and that the transmit end performs first processing on the N layers of first bit sequences, to obtain first information includes: The transmit end performs channel coding on a layer-n first bit sequence in the N layers of first bit sequences, to obtain a layer-n second bit sequence, where n=1, 2, . . . , and N; and the transmit end performs bit clipping on the layer-n second bit sequence, to obtain a layer-n third bit sequence, where the layer-n third bit sequence is a part of the layer-n second bit sequence other than some or all bits in the layer-n first bit sequence. In this possible implementation, the original information may be compressed through bit clipping, to reduce a transmission resource requirement of a system.

In a possible implementation, the first processing is rateless coding, and that the transmit end performs first processing on the N layers of first bit sequences, to obtain first information includes: The transmit end performs rateless coding on a layer-n first bit sequence in the N layers of first bit sequences, to obtain a layer-n third bit sequence, where n=1, 2, . . . , and N. In this possible implementation, the original information may be compressed through rateless coding, to reduce a transmission resource requirement of a system.

In a possible implementation, a channel coding manner with a lower coding rate and/or a longer code length is used for a more important first bit sequence in the N layers of first bit sequences. In this possible implementation, because there are more redundant bits in a sequence obtained after channel coding is performed in the channel coding manner with a lower coding rate and/or a longer code length, the channel coding manner with a lower coding code rate and/or a longer code length is more reliable, so that a probability that the receive end correctly decodes more important information can be increased, data transmission reliability can be improved, and a channel adaptation capability of data can be improved.

In a possible implementation, the second processing includes bit splicing and constellation modulation, and that the transmit end performs second processing on the first information, to obtain second information includes: The transmit end performs bit splicing on N layers of third bit sequences, to obtain one layer of fourth bit sequences; and the transmit end performs constellation modulation on the fourth bit sequence, to obtain the second information.

In a possible implementation, during constellation modulation, a more important bit in the fourth bit sequence is mapped onto a higher-order bit of a constellation symbol. In this possible implementation, a higher-order bit of the constellation symbol has higher energy. Therefore, according to this optional method, a probability that the receive end decodes more important information can be increased, to ensure transmission reliability of important data, and improve a channel adaptive capability of data.

In a possible implementation, the second processing includes bit splicing, constellation modulation, and constellation symbol splicing, and that the transmit end performs second processing on the first information, to obtain second information includes: The transmit end performs bit splicing on N layers of third bit sequences, to obtain M layers of fourth bit sequences, where a layer-m fourth bit sequence in the M layers of fourth bit sequences includes the m^{th} bit in all third bit sequences that are in the N layers of third bit sequences and that include the m^{th} bit, M is an integer greater than 1, and m is an integer greater than 0 and less than or equal to M; the transmit end separately performs constellation modulation on the M layers of fourth bit sequences, to obtain M layers of constellation symbol sequences; and the transmit end performs constellation symbol splicing on the M layers of constellation symbol sequences, to obtain the second information.

In a possible implementation, a modulation mode with a lower modulation order is used for a more important fourth bit sequence in the M layers of fourth bit sequences. In this possible implementation, a more reliable constellation modulation mode may be used for more important information, to improve a probability that the receive end correctly demodulates important information, and improve data transmission reliability.

In a possible implementation, the second processing includes constellation modulation and constellation symbol splicing, and that the transmit end performs second processing on the first information, to obtain second information includes: The transmit end separately performs constellation modulation on N layers of third bit sequences, to obtain N layers of constellation symbol sequences; and the transmit end performs constellation symbol splicing on the N layers of constellation symbol sequences, to obtain the second information.

In a possible implementation, a modulation mode with a lower modulation order is used for a more important third bit sequence in the N layers of third bit sequences. In this possible implementation, a more reliable constellation modulation mode may be used for more important information, to improve a probability that the receive end correctly demodulates important information, and improve data transmission reliability.

In a possible implementation, a more important bit in each of the N layers of third bit sequences is mapped onto a higher-order bit of a constellation symbol in a corresponding constellation symbol sequence. In this possible implementation, a higher-order bit of the constellation symbol has higher energy. Therefore, according to this optional method, a probability that the receive end decodes more important information can be increased, to ensure transmission reliability of important data, and improve a channel adaptive capability of data.

According to a second aspect, a data processing method is provided, including: A receive end receives second information and third information from a transmit end, where the second information is obtained by performing second processing on first information by the transmit end, the first information is obtained by performing first processing on N layers of first bit sequences by the transmit end, the first information does not include all bits in the N layers of first bit sequences or the first information includes some bits in the N layers of first bit sequences, the N layers of first bit sequences are obtained by layering original information by the transmit end, the original information is at least one bit sequence or at least one integer, the third information is obtained by performing channel coding and constellation modulation on coding information of the N layers of first bit sequences by the transmit end, the coding information is used to indicate proportion information of 0 or 1 in each of the N layers of first bit sequences, and N is an integer greater than 1; the receive end performs constellation demodulation and channel decoding on the third information, to obtain the restored coding information; the receive end performs third processing on the second information, to obtain first soft information, where the first soft information is a log-likelihood ratio corresponding to each bit in the first information; the receive end performs fourth processing on the first soft information based on the coding information, to obtain second soft information, where the second soft information is a log-likelihood ratio corresponding to a bit in each of the N layers of first bit sequences; and the receive end reconstructs the second soft information, to obtain the restored original information. In the method provided in the second aspect, the transmit end may send, to the receive end, the coding information of the N layers of first bit sequences and second information that does not include some or all bits in the N layers of first bit sequences, and the receive end may process the coding information and the second information, to obtain the N layers of first bit sequences. Because the transmit end sends the coding information to the receive end, information sent by the transmit end may not include some or all bits in the N layers of first bit sequences. Therefore, a requirement of data for bandwidth is lowered, and data coding efficiency is improved.

In a possible implementation, the third processing includes constellation demodulation and soft information splitting, and that the receive end performs third processing on the second information, to obtain first soft information includes: The receive end performs constellation demodulation on the second information, to obtain third soft information, where the third soft information is a log-likelihood ratio corresponding to each bit in a fourth bit sequence, the fourth bit sequence is obtained by performing bit splicing on N layers of third bit sequences by the transmit end, and the N layers of third bit sequences are the first information; and the receive end performs soft information splitting on the third soft information, to obtain the first soft information, where the first soft information includes N layers of soft information, and one layer of soft information is a log-likelihood ratio corresponding to a bit in one of the N layers of third bit sequences.

In a possible implementation, the third processing includes constellation symbol splitting, constellation demodulation, and soft information splitting, and that the receive end performs third processing on the second information, to obtain first soft information includes: The receive end performs constellation symbol splitting on the second information, to obtain M layers of constellation symbol sequences, where the M layers of constellation symbol sequences are obtained by performing constellation modulation on M layers of fourth bit sequences by the transmit end, the M layers of fourth bit sequences are obtained by performing bit splicing on N layers of third bit sequences by the transmit end, a layer-m fourth bit sequence in the M layers of fourth bit sequences includes the m^{th} bit in all third bit sequences that are in the N layers of third bit sequences and that include the m^{th} bit, the N layers of third bit sequences are the first information, M is an integer greater than 1, and m is an integer greater than 0 and less than or equal to M; the receive end separately performs constellation demodulation on the M layers of constellation symbol sequences, to obtain M layers of third soft information, where the M layers of third soft information each are a log-likelihood ratio corresponding to a bit in the M layers of fourth bit sequences; and the receive end performs soft information splitting on the M layers of third soft information, to obtain the first soft information, where the first soft information includes N layers of soft information, and one layer of soft information is a log-likelihood ratio corresponding to a bit in one of the N layers of third bit sequences.

In a possible implementation, the third processing includes constellation symbol splitting and constellation demodulation, and that the receive end performs third processing on the second information, to obtain first soft information includes: The receive end performs constellation symbol splitting on the second information, to obtain N layers of constellation symbol sequences, where the N layers of constellation symbol sequences are obtained by separately performing constellation modulation on N layers of third bit sequences by the transmit end, and the N layers of third bit sequences are the first information; and the receive end separately performs constellation demodulation on the N layers of constellation symbol sequences, to obtain first soft information, where the first soft information includes N layers of soft information, and one layer of soft information is a log-likelihood ratio corresponding to a bit in one of the N layers of third bit sequences.

In a possible implementation, the fourth processing includes soft information splicing and channel decoding, and that the receive end performs fourth processing on the first soft information based on the coding information, to obtain second soft information includes: The receive end performs soft information calculation based on the coding information, to obtain a log-likelihood ratio sequentially corresponding to a bit that is in a layer-n first bit sequence in the N layers of first bit sequences and that is clipped in a bit clipping process, where n=1, 2, . . . , and N; the receive end performs soft information splicing on the log-likelihood ratio sequentially corresponding to the bit that is in the layer-n first bit sequence and that is clipped in the bit clipping process and a log-likelihood ratio in the n^{th} layer of soft information in the first soft information, to obtain a soft information sequence corresponding to a layer-n second bit sequence, where the soft information sequence corresponding to the layer-n second bit sequence includes a log-likelihood ratio sequentially corresponding to a bit in the layer-n second bit sequence, the log-likelihood ratio in the n^{th} layer of soft information is a log-likelihood ratio corresponding to a bit in a layer-n third bit sequence in the N layers of third bit sequences, the layer-n third bit sequence is obtained by performing bit clipping on the layer-n second bit sequence by the transmit end, the layer-n second bit sequence is obtained by performing channel coding on the layer-n first bit sequence in the N layers of first bit sequences by the transmit end, and the layer-n third bit sequence is a part of the layer-n second bit sequence other than some or all bits in the layer-n first bit sequence; and the receive end performs channel decoding on a soft information sequence corresponding to each of N layers of second bit sequences, to obtain the second soft information, where the second soft information includes a log-likelihood ratio corresponding to a bit in each of the N layers of first bit sequences.

In a possible implementation, the fourth processing is rateless decoding, and that the receive end performs fourth processing on the first soft information based on the coding information, to obtain second soft information includes: The receive end performs soft information calculation based on the coding information, to obtain a log-likelihood ratio sequentially corresponding to a bit in a layer-n first bit sequence in the N layers of first bit sequences, where n=1, 2, . . . , and N; and the receive end performs rateless decoding on the first soft information based on the log-likelihood ratio that sequentially corresponds to the bit in each of the N layers of first bit sequences and that is obtained through soft information calculation, to obtain second soft information, where the second soft information includes the log-likelihood ratio corresponding to the bit in each of the N layers of first bit sequences.

According to a third aspect, a transmit end apparatus is provided, including a processing unit and a sending unit. The processing unit is configured to: layer original information, to obtain N layers of first bit sequences; perform first processing on the N layers of first bit sequences, to obtain first information; perform second processing on the first information, to obtain second information; and perform channel coding and constellation modulation on coding information of the N layers of first bit sequences, to obtain third information. The original information is at least one bit sequence or at least one integer, the first information does not include all bits in the N layers of first bit sequences or the first information includes some bits in the N layers of first bit sequences, the coding information is used to indicate proportion information of 0 or 1 in each of the N layers of first bit sequences, and N is an integer greater than 1. The sending unit is configured to send the second information and the third information to a receive end.

In a possible implementation, the processing unit is configured to layer the original information in descending order or ascending order of importance of information in the original information, to obtain the N layers of first bit sequences.

In a possible implementation, the first processing includes channel coding and bit clipping, and the processing unit is configured to: perform channel coding on a layer-n first bit sequence in the N layers of first bit sequences, to obtain a layer-n second bit sequence, where n=1, 2, . . . , and N; and perform bit clipping on the layer-n second bit sequence, to obtain a layer-n third bit sequence, where the layer-n third bit sequence is a part of the layer-n second bit sequence other than some or all bits in the layer-n first bit sequence.

In a possible implementation, the first processing is rateless coding, and the processing unit is configured to perform rateless coding on a layer-n first bit sequence in the N layers of first bit sequences, to obtain a layer-n third bit sequence, where n=1, 2, . . . , and N.

In a possible implementation, a channel coding manner with a lower coding rate and/or a longer code length is used for a more important first bit sequence in the N layers of first bit sequences.

In a possible implementation, the second processing includes bit splicing and constellation modulation, and the processing unit is configured to: perform bit splicing on N layers of third bit sequences, to obtain one layer of fourth bit sequences; and perform constellation modulation on the fourth bit sequence, to obtain the second information.

In a possible implementation, during constellation modulation, a more important bit in the fourth bit sequence is mapped onto a higher-order bit of a constellation symbol.

In a possible implementation, the second processing includes bit splicing, constellation modulation, and constellation symbol splicing, and the processing unit is configured to: perform bit splicing on N layers of third bit sequences, to obtain M layers of fourth bit sequences, where a layer-m fourth bit sequence in the M layers of fourth bit sequences includes the m^{th} bit in all third bit sequences that are in the N layers of third bit sequences and that include the m^{th} bit, M is an integer greater than 1, and m is an integer greater than 0 and less than or equal to M; separately perform constellation modulation on the M layers of fourth bit sequences, to obtain M layers of constellation symbol sequences; and perform constellation symbol splicing on the M layers of constellation symbol sequences, to obtain the second information.

In a possible implementation, a modulation mode with a lower modulation order is used for a more important fourth bit sequence in the M layers of fourth bit sequences.

In a possible implementation, the second processing includes constellation modulation and constellation symbol splicing, and the processing unit is configured to: separately perform constellation modulation on N layers of third bit sequences, to obtain N layers of constellation symbol sequences; and perform constellation symbol splicing on the N layers of constellation symbol sequences, to obtain the second information.

In a possible implementation, a modulation mode with a lower modulation order is used for a more important third bit sequence in the N layers of third bit sequences.

In a possible implementation, a more important bit in each of the N layers of third bit sequences is mapped onto a higher-order bit of a constellation symbol in a corresponding constellation symbol sequence.

According to a fourth aspect, a receive end apparatus is provided, including a receiving unit and a processing unit. The receiving unit is configured to receive second information and third information from a transmit end, where the second information is obtained by performing second processing on first information by the transmit end, the first information is obtained by performing first processing on N layers of first bit sequences by the transmit end, the first information does not include all bits in the N layers of first bit sequences or the first information includes some bits in the N layers of first bit sequences, the N layers of first bit sequences are obtained by layering original information by the transmit end, the original information is at least one bit sequence or at least one integer, the third information is obtained by performing channel coding and constellation modulation on coding information of the N layers of first bit sequences by the transmit end, the coding information is used to indicate proportion information of 0 or 1 in each of the N layers of first bit sequences, and N is an integer greater than 1; the processing unit is configured to: perform constellation demodulation and channel decoding on the third information, to obtain the restored coding information; perform third processing on the second information, to obtain first soft information; perform fourth processing on the first soft information based on the coding information, to obtain second soft information; and reconstruct the second soft information, to obtain the restored original information, where the first soft information is a log-likelihood ratio corresponding to each bit in the first information, and the second soft information is a log-likelihood ratio corresponding to a bit in each of the N layers of first bit sequences.

In a possible implementation, the third processing includes constellation demodulation and soft information splitting, and the processing unit is configured to: perform constellation demodulation on the second information, to obtain third soft information, where the third soft information is a log-likelihood ratio corresponding to each bit in a fourth bit sequence, the fourth bit sequence is obtained by performing bit splicing on N layers of third bit sequences by the transmit end, and the N layers of third bit sequences are the first information; and perform soft information splitting on the third soft information, to obtain the first soft information, where the first soft information includes N layers of soft information, and one layer of soft information is a log-likelihood ratio corresponding to a bit in one of the N layers of third bit sequences.

In a possible implementation, the third processing includes constellation symbol splitting, constellation demodulation, and soft information splitting, and the processing unit is configured to: perform constellation symbol splitting on the second information, to obtain M layers of constellation symbol sequences, where the M layers of constellation symbol sequences are obtained by performing constellation modulation on M layers of fourth bit sequences by the transmit end, the M layers of fourth bit sequences are obtained by performing bit splicing on N layers of third bit sequences by the transmit end, a layer-m fourth bit sequence in the M layers of fourth bit sequences includes the m^{th} bit in all third bit sequences that are in the N layers of third bit sequences and that include the m^{th} bit, the N layers of third bit sequences are the first information, M is an integer greater than 1, and m is an integer greater than 0 and less than or equal to M; separately perform constellation demodulation on the M layers of constellation symbol sequences, to obtain M layers of third soft information, where the M layers of third soft information each are a log-likelihood ratio corresponding to a bit in the M layers of fourth bit sequences; and perform soft information splitting on the M layers of third soft information, to obtain the first soft information, where the first soft information includes N layers of soft information, and one layer of soft information is a log-likelihood ratio corresponding to a bit in one of the N layers of third bit sequences.

In a possible implementation, the third processing includes constellation symbol splitting and constellation demodulation, and the processing unit is configured to: perform constellation symbol splitting on the second information, to obtain N layers of constellation symbol sequences, where the N layers of constellation symbol sequences are obtained by separately performing constellation modulation on N layers of third bit sequences by the transmit end, and the N layers of third bit sequences are the first information; and separately perform constellation demodulation on the N layers of constellation symbol sequences, to obtain first soft information, where the first soft information includes N layers of soft information, and one layer of soft information is a log-likelihood ratio corresponding to a bit in one of the N layers of third bit sequences.

In a possible implementation, the fourth processing includes soft information splicing and channel decoding, and the processing unit is configured to: perform soft information calculation based on the coding information, to obtain a log-likelihood ratio sequentially corresponding to a bit that is in a layer-n first bit sequence in the N layers of first bit sequences and that is clipped in a bit clipping process, where n=1, 2, . . . , and N; perform soft information splicing on the log-likelihood ratio sequentially corresponding to the bit that is in the layer-n first bit sequence and that is clipped in the bit clipping process and a log-likelihood ratio in the n^{th} layer of soft information in the first soft information, to obtain a soft information sequence corresponding to a layer-n second bit sequence, where the soft information sequence corresponding to the layer-n second bit sequence includes a log-likelihood ratio sequentially corresponding to a bit in the layer-n second bit sequence, the log-likelihood ratio in the n^{th} layer of soft information is a log-likelihood ratio corresponding to a bit in a layer-n third bit sequence in the N layers of third bit sequences, the layer-n third bit sequence is obtained by performing bit clipping on the layer-n second bit sequence by the transmit end, the layer-n second bit sequence is obtained by performing channel coding on the layer-n first bit sequence in the N layers of first bit sequences by the transmit end, and the layer-n third bit sequence is a part of the layer-n second bit sequence other than some or all bits in the layer-n first bit sequence; and perform channel decoding on a soft information sequence corresponding to each of N layers of second bit sequences, to obtain the second soft information, where the second soft information includes a log-likelihood ratio corresponding to a bit in each of the N layers of first bit sequences.

In a possible implementation, the fourth processing is rateless decoding, and the processing unit is configured to: perform soft information calculation based on the coding information, to obtain a log-likelihood ratio sequentially corresponding to a bit in a layer-n first bit sequence in the N layers of first bit sequences, where n=1, 2, . . . , and N; and perform rateless decoding on the first soft information based on the log-likelihood ratio that sequentially corresponds to the bit in each of the N layers of first bit sequences and that is obtained through soft information calculation, to obtain second soft information, where the second soft information includes the log-likelihood ratio corresponding to the bit in each of the N layers of first bit sequences.

According to a fifth aspect, a transmit end apparatus is provided, including a processor. The processor is configured to execute computer instructions, to implement any method provided in the first aspect.

In a possible implementation, the transmit end apparatus further includes a memory. The processor is coupled to the memory, and the memory is configured to store the computer instructions.

In a possible implementation, the memory and the processor are integrated together, or the memory and the processor are independent components.

In a possible implementation, the transmit end apparatus further includes a communications interface and a communications bus. The processor, the memory, and the communications interface are connected by using the communications bus. The communications interface is configured to perform a sending action in a corresponding method. For example, the communications interface performs a sending action in a corresponding method by using a transmitter.

According to a sixth aspect, a receive end apparatus is provided, including a processor. The processor is configured to execute computer instructions, to implement any method provided in the second aspect.

In a possible implementation, the receive end apparatus further includes a memory. The processor is coupled to the memory, and the memory is configured to store the computer instructions.

In a possible implementation, the memory and the processor are integrated together, or the memory and the processor are independent components.

In a possible implementation, the receive end apparatus further includes a communications interface and a communications bus. The processor, the memory, and the communications interface are connected by using the communications bus. The communications interface is configured to perform a receiving action in a corresponding method. For example, the communications interface performs a receiving action in a corresponding method by using a receiver.

According to a seventh aspect, a transmit end apparatus is provided, including a logical circuit and an output interface. The logical circuit and the output interface are configured to implement any method provided in the first aspect. The logical circuit is configured to perform a processing action in a corresponding method, and the output interface is configured to perform a sending action in a corresponding method.

According to an eighth aspect, a receive end apparatus is provided, including a logical circuit and an input interface. The logical circuit and the input interface are configured to implement any method provided in the second aspect. The logical circuit is configured to perform a processing action in a corresponding method, and the input interface is configured to perform a receiving action in a corresponding method.

According to a ninth aspect, a communications system is provided, including a transmit end apparatus provided in the third aspect and a receive end apparatus provided in the fourth aspect; the transmit end apparatus provided in the fifth aspect and the receive end apparatus provided in the sixth aspect; or the transmit end apparatus provided in the seventh aspect and the receive end apparatus provided in the eighth aspect.

According to a tenth aspect, a computer-readable storage medium is provided. The computer-readable storage medium stores computer instructions, and when the computer instructions run on a computer, the computer is enabled to perform any method provided in the first aspect.

According to an eleventh aspect, a computer-readable storage medium is provided. The computer-readable storage medium stores computer instructions, and when the computer instructions run on a computer, the computer is enabled to perform any method provided in the second aspect.

According to a twelfth aspect, a computer program product including computer instructions is provided. When the computer instructions are run on a computer, the computer is enabled to perform any method provided in the first aspect.

According to a thirteenth aspect, a computer program product including computer instructions is provided. When the computer instructions are run on a computer, the computer is enabled to perform any method provided in the second aspect.

According to a fourteenth aspect, a transmit end apparatus is provided, including a processor. The processor is coupled to a memory, the memory is configured to store computer-executable instructions, and the processor executes the computer-executable instructions stored in the memory, so that the apparatus performs any method provided in the first aspect.

In a possible implementation, the memory is located inside the transmit end apparatus.

In a possible implementation, the memory is located outside the transmit end apparatus.

According to a fifteenth aspect, a receive end apparatus is provided, including a processor. The processor is coupled to a memory, the memory is configured to store computer-executable instructions, and the processor executes the computer-executable instructions stored in the memory, so that the apparatus performs any method provided in the second aspect.

In a possible implementation, the memory is located inside the receive end apparatus.

In a possible implementation, the memory is located outside the receive end apparatus.

For a technical effect brought by any implementation of the third to the fifteenth aspects, refer to a technical effect brought by a corresponding implementation of the first aspect and the second aspect. Details are not described herein again.

It should be noted that various possible implementations of any one of the foregoing aspects may be combined provided that the solutions are not contradictory.

### BRIEF DESCRIPTION OF DRAWINGS

FIG. 1 is a schematic diagram of composition of a network architecture;

FIG. 2 is a schematic diagram of a data processing procedure at a transmit end and a receive end;

FIG. 3 is a flowchart of a data processing method according to an embodiment of this application;

FIG. 4 is a schematic flowchart of data processing according to an embodiment of this application;

FIG. 5 is a schematic diagram of performing binary conversion on a DCT quantization coefficient according to an embodiment of this application;

FIG. 6A and FIG. 6B to FIG. 11A and FIG. 11B each are a schematic diagram of a data processing procedure according to an embodiment of this application;

FIG. 12 is a schematic diagram of composition of a transmit end apparatus according to an embodiment of this application;

FIG. 13 and FIG. 14 each are a schematic diagram of a hardware structure of a transmit end apparatus according to an embodiment of this application;

FIG. 15 is a schematic diagram of composition of a receive end apparatus according to an embodiment of this application; and

FIG. 16 and FIG. 17 each are a schematic diagram of a hardware structure of a receive end apparatus according to an embodiment of this application.

### DETAILED DESCRIPTION

The following describes technical solutions in embodiments of this application with reference to the accompanying drawings. In descriptions of this application, unless otherwise specified, “/” means “or”. For example, A/B may represent A or B. The term “and/or” in this specification describes an association relationship between associated objects and represents that there may be three relationships. For example, A and/or B may represent the following three cases: Only A exists, both A and B exist, and only B exists.

In the descriptions of this application, the term “a plurality of” means two or more than two unless otherwise specified. In addition, to clearly describe technical solutions in embodiments of this application, terms such as “first” and “second” are used to distinguish between same objects or similar objects whose functions and purposes are basically the same. A person skilled in the art may understand that the terms such as “first” and “second” are not intended to limit a quantity or an execution sequence, and the terms such as “first” and “second” do not indicate a definite difference.

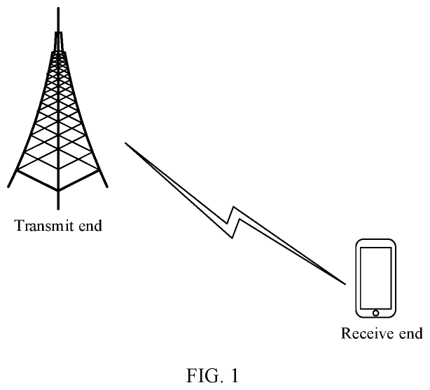

An embodiment of this application provides a communications system. The communications system includes a transmit end and a receive end. The transmit end may be a network device or a terminal. When the transmit end is a network device, the receive end may be a terminal. When the transmit end is a terminal, the receive end may be a network device, or may be a terminal. When the transmit end is a network device, and the receive end is a terminal, for a schematic architectural diagram of the communications system, refer to FIG. 1.

The network device may be an apparatus that is deployed in a radio access network (RAN) and that provides a wireless communication function for the terminal, for example, may be a base station and control nodes in various forms (for example, a network controller and a radio controller (for example, a radio controller in a cloud radio access network (CRAN) scenario)). For example, the network device may be macro base stations, micro base stations (also referred to as small cells), relay stations, access points (APs), or the like in various forms, or may be an antenna panel of a base station. The control node may be connected to a plurality of base stations, and configure resources for a plurality of terminals covered by the plurality of base stations. In systems using different radio access technologies, names of devices having functions of a base station may vary. For example, a device with the function of a base station in a long term evolution (LTE) system may be referred to as an evolved NodeB (eNB, or eNodeB), and a device with the function of a base station in a 5th generation (5G) system or a new radio (NR) system may be referred to as a next generation node base station (gNB). A specific name of the base station is not limited in this application. The network device may alternatively be a network device in a future evolved public land mobile network (PLMN) or the like.

The terminal may be a device that provides voice or data connectivity for a user, and may also be referred to as, for example, user equipment (UE), a mobile station, a subscriber unit, a station, or terminal equipment (TE). For example, the terminal may be a cellular phone, a personal digital assistant (PDA), a wireless modem, a handheld device, a laptop computer, a cordless phone, a wireless local loop (WLL) station, a pad, a smartphone, customer premises equipment (CPE), or a sensor with a network access function. With development of wireless communications technologies, a device that can access the communications system, a device that can communicate with a network side in the communications system, or a device that can communicate with another object by using the communications system may be the terminal in embodiments of this application, such as a terminal and a vehicle in intelligent transportation, a household device in a smart household, an electricity meter reading instrument or a voltage monitoring instrument in a smart grid, an environment monitoring instrument, a video surveillance instrument in an intelligent security network, or a cash register.

Technical solutions provided in embodiments of this application may be applied to a plurality of communication scenarios, for example, a machine to machine (M2M) scenario, a macro-micro communication scenario, an enhanced mobile broadband (eMBB) scenario, an ultra-reliable and low-latency communication (URLLC) scenario, and a massive machine-type communications (mMTC) scenario.

A network architecture and a service scenario that are described in embodiments of this application are intended to describe technical solutions in embodiments of this application more clearly, and do not constitute a limitation on technical solutions provided in embodiments of this application. A person of ordinary skill in the art may learn that technical solutions provided in embodiments of this application are also applicable to a similar technical problem as a network architecture evolves and a new service scenario emerges.

To make this application clearer, some concepts and content mentioned in this application are first briefly described.

### 1. General Data Sending and Receiving Procedure

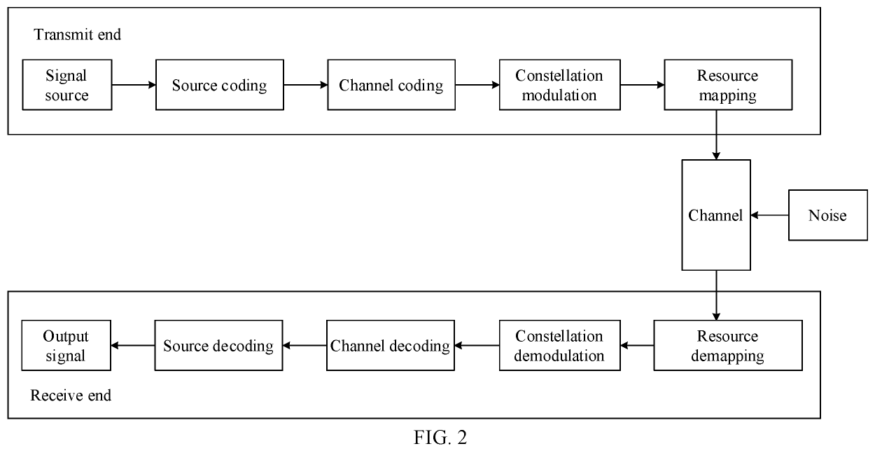

Refer to FIG. 2. In a data sending and receiving process, a transmit end sends, to a receive end, a signal obtained after source coding, channel coding, constellation modulation, and resource mapping are performed on a signal source. When the signal is transmitted on a channel between the transmit end and the receive end, the signal may be interfered by noise. After receiving the signal, the receive end performs resource demapping, constellation demodulation, channel decoding, and source decoding on the signal, to obtain an output signal (namely, the restored signal source).

FIG. 2 shows only some steps of the data sending and receiving process. In an actual implementation, there may be other steps. This is not limited in embodiments of this application.

### 2. Source Coding

Source coding is a transformation performed on a signal source to improve communication effectiveness, or is a transformation performed on a signal source to reduce or eliminate source redundancy. Specifically, a method is searched for based on a statistical characteristic of the signal source, to transform the signal source into a shortest bit sequence, so that each bit in the shortest bit sequence carries a maximum average information amount, and it can be further ensured that the original signal source is restored without distortion.

An inverse process of source coding is source decoding, and source decoding is a process in which a signal existing before source decoding is restored to a signal source.

### 3. Channel Coding

Channel coding is also referred to as error control coding, and means that a transmit end adds a redundant bit to an information bit (for example, a bit obtained after source coding in FIG. 2). The redundant bit is related to the information bit. A signal obtained after channel coding sequentially includes the information bit and the redundant bit.

An inverse process of channel coding is channel decoding, and channel decoding means that a receive end detects and corrects an error generated in a transmission process based on a correlation between a redundant bit and an information bit, and restores the information bit, to resist interference in a transmission process and improve data transmission reliability.

### 4. Constellation Modulation

Constellation modulation is to map a bit in a bit sequence onto a constellation symbol in a constellation diagram. One constellation symbol includes one or more bits, and one bit in the bit sequence may be mapped onto one bit in the constellation symbol.

Constellation modulation aims to process, in time domain, frequency domain, or code domain, a digital signal (for example, the bit sequence) that needs to be transmitted, to transmit as much information as possible by using as small bandwidth as possible.

An inverse process of constellation modulation is constellation demodulation, and constellation demodulation is a process of restoring a bit sequence from a constellation symbol.

### 5. Resource Mapping

Resource mapping is a process of mapping a signal (for example, a signal obtained after constellation modulation in FIG. 2) onto a transmission resource (for example, a time domain resource, a frequency domain resource, or a spatial domain resource).

An inverse process of resource mapping is resource demapping, and resource demapping is a process of restoring, to a signal existing before mapping, a signal mapped onto a transmission resource.

### 6. Rateless Coding

Rateless coding is a channel coding manner. A signal obtained after rateless coding includes only a redundant bit.

### 7. Coding Rate

The coding rate is a proportion of a bit (namely, an information bit) existing before coding to a bit obtained after coding. If a bit sequence is coded in a coding manner with a lower coding rate, there are more redundant bits in the coded bit sequence and higher data transmission reliability.

### 8. Code Length

The code length is a quantity of bits in a coded bit sequence. When there is a fixed quantity of information bits, if coding is performed in a coding manner with a longer code length, there are more redundant bits in the coded bit sequence and higher data transmission reliability.

### 9. Modulation Order

The modulation order is used to calculate a quantity of bits that can be represented by each constellation symbol. Modulation orders corresponding to binary phase shift keying (BPSK), quadrature phase shift keying (QPSK), 8 quadrature amplitude modulation (QAM), 16QAM, 32QAM, 64QAM, and 256QAM are respectively 2, 4, 8, 16, 32, 64, and 256. Quantities that are of bits and that correspond to these modulation orders are respectively log₂(2) (namely, 1), log₂(4) (namely, 2), log₂(8) (namely, 3), log₂(16) (namely, 4), log₂(32) (namely, 5), log₂(64) (namely, 6), and log₂(256) (namely, 8).

A higher the modulation order results in a higher-order bit error rate (BER). It can be understood from a constellation diagram that a higher modulation order results in denser constellation symbols (namely, constellation points). For example, when the modulation order is 32, there are 32 constellation symbols in the constellation diagram, and when the modulation order is 64, there are 64 constellation symbols in the constellation diagram. Denser constellation symbols in the constellation diagram indicate a shorter distance between the constellation symbols, and results in a higher probability that another constellation symbol is determined. Therefore, there is a higher BER.

### 10. Log-Likelihood Ratio

A log-likelihood ratio of a bit means that a ratio of a probability that the bit is 1 to a probability that the bit is 0 is a natural logarithm. If the probability that the bit is 1 is denoted as p(1), and the probability that the bit is 0 is denoted as p(0), the log-likelihood ratio of the bit is ln[p(1)/p(0)].

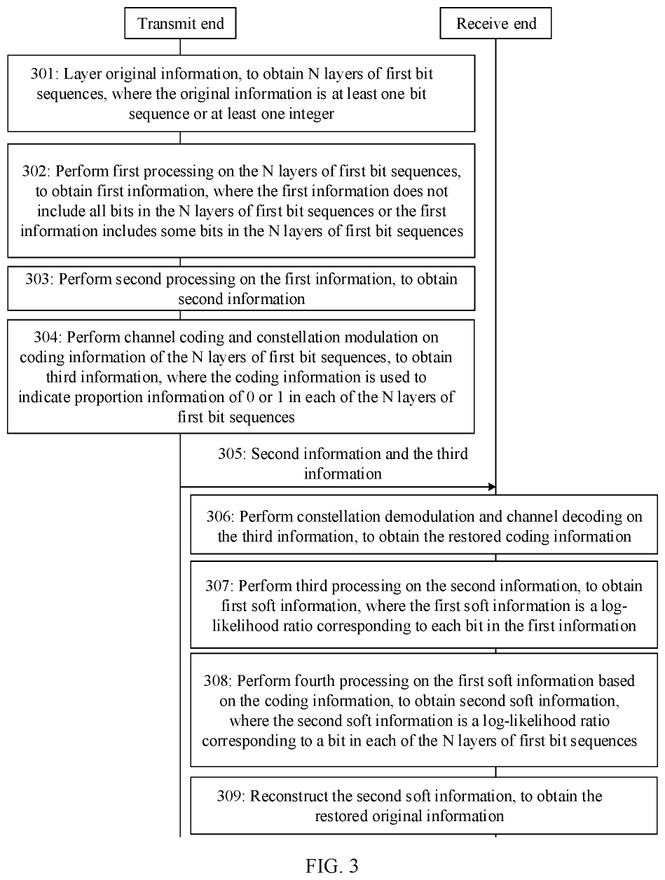

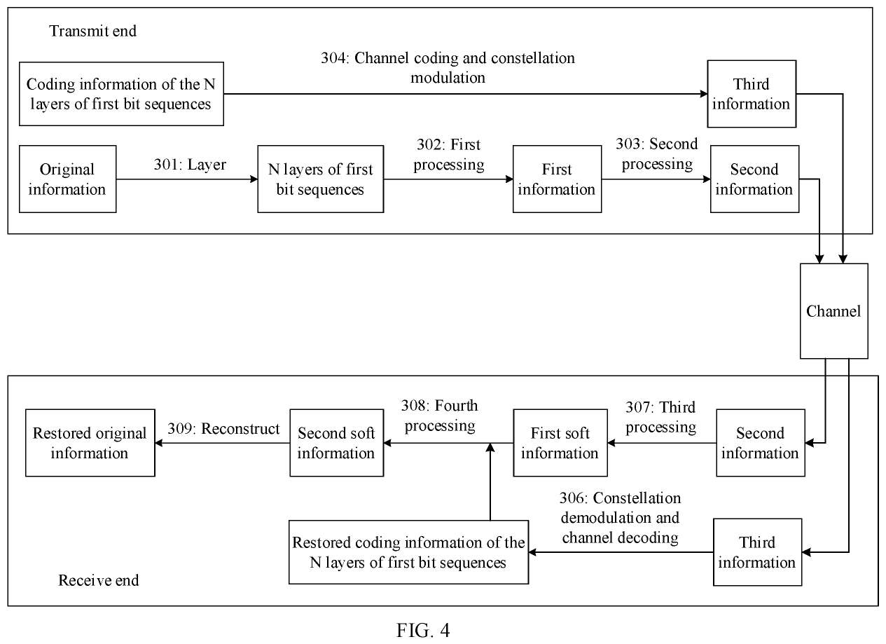

An embodiment of this application provides a data processing method. As shown in FIG. 3 or FIG. 4, the method includes the following steps.

301: A transmit end layers original information, to obtain N layers of first bit sequences, where the original information is at least one bit sequence or at least one integer, and N is an integer greater than 1.

The transmit end in this embodiment of this application may be a terminal, a network device, a chip in the terminal (for example, a short-range communications chip configured to implement a function such as high-speed and low-delay projection), or a chip in the network device.

In this embodiment of this application, the original information may have the following two cases:

Case 1: The original information is one or more bit sequences obtained after source coding is performed on data such as a video, an instruction, a speech, an image, or a text, or the original information is one or more bit sequences obtained after binary conversion is performed on a discrete cosine transform (DCT) quantization coefficient.

The DCT quantization coefficient includes one or more integers.

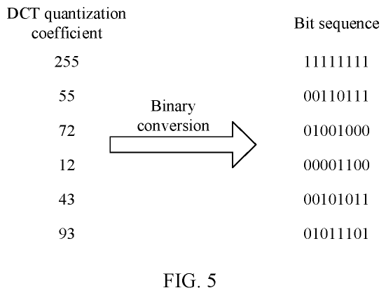

For example, the original information may be one bit sequence obtained after source coding is performed on video data, for example, 10001100001101110110010011000011. Alternatively, the original information may be four bit sequences obtained after source coding is performed on the video data, for example, 10001100, 00110111, 01100100, and 11000011. The original information may alternatively be one or more bit sequences obtained after binary conversion is performed on one or more integers in the DCT quantization coefficient. A quantity of bits included in the one or more bit sequences is a binary conversion bit quantity. For example, referring to FIG. 5, if DCT quantization coefficients are 255, 55, 72, 12, 43, and 93, six bit sequences may be obtained after binary conversion is performed based on a binary conversion bit quantity of 8, and are respectively 11111111, 00110111, 01001000, 00001100, 00101011, and 01011101. The six bit sequences are original information, one bit sequence corresponds to an integer in the DCT quantization coefficient, and integers corresponding to 11111111, 00110111, 01001000, 00001100, 00101011, and 01011101 are respectively 255, 55, 72, 12, 43, and 93.

Case 2: The original information is a DCT quantization coefficient.

The DCT quantization coefficient includes one or more integers. For example, DCT quantization coefficients are 255, 55, 72, 12, 43, and 93.

In Case 1 and Case 2, for the image or the video, the transmit end may perform DCT transformation on a pixel value of a pixel in the image to obtain a DCT coefficient, and then quantize the DCT coefficient to obtain a DCT quantization coefficient. The DCT coefficient is a real number, and the DCT quantization coefficient is an integer.

302: The transmit end performs first processing on the N layers of first bit sequences, to obtain first information, where the first information does not include all bits in the N layers of first bit sequences or the first information includes some bits in the N layers of first bit sequences.

303: The transmit end performs second processing on the first information, to obtain second information.

304: The transmit end performs channel coding and constellation modulation on coding information of the N layers of first bit sequences, to obtain third information, where the coding information is used to indicate proportion information of 0 or 1 in each of the N layers of first bit sequences.

For example, the coding information may be the proportion information of 0 or 1 in each of the N layers of first bit sequences.

Step 304 may be performed after step 303, or may be performed before step 303 or step 302.

305: The transmit end sends the second information and the third information to a receive end. Correspondingly, the receive end receives the second information and the third information from the transmit end.

The receive end in this embodiment of this application may be a terminal, a network device, a chip in the terminal (for example, a short-range communications chip configured to implement a function such as high-speed and low-delay projection), or a chip in the network device.

306: The receive end performs constellation demodulation and channel decoding on the third information, to obtain the restored coding information.

307: The receive end performs third processing on the second information, to obtain first soft information, where the first soft information is a log-likelihood ratio corresponding to each bit in the first information.

An execution sequence of step 306 and step 307 is not limited.

308: The receive end performs fourth processing on the first soft information based on the coding information, to obtain second soft information, where the second soft information is a log-likelihood ratio corresponding to a bit in each of the N layers of first bit sequences.

309: The receive end reconstructs the second soft information, to obtain the restored original information.

In the foregoing method, the N layers of first bit sequences may also be referred to as a data information bit sequence, and the coding information may also be referred to as distribution information a probability that a bit is 0/1 before coding or a control information bit.

The procedures shown in FIG. 3 and FIG. 4 are merely basic procedures that include an innovation point in this application and that are provided in this application. During an actual implementation, the transmit end and the receive end may further perform another operation. For example, before the second information and the third information are transmitted on a channel, the transmit end may further perform resource mapping (in other words, map the second information and the third information onto a transmission resource for transmission). Correspondingly, after the second information and the third information are transmitted on the channel, the receive end may further perform resource demapping (in other words, extract the second information and the third information from the transmission resource), to obtain the second information and the third information. For another example, after performing resource mapping, the transmit end may further perform block assembly. Correspondingly, the receive end may further perform channel estimation and equalization before performing resource demapping.

In the method provided in this embodiment of this application, the transmit end may send, to the receive end, the coding information of the N layers of first bit sequences and second information that does not include some or all bits in the N layers of first bit sequences, and the receive end may process the coding information and the second information, to obtain the N layers of first bit sequences. Because the transmit end sends the coding information to the receive end, information sent by the transmit end may not include some or all bits in the N layers of first bit sequences. Therefore, a requirement of data for bandwidth is lowered, and data coding efficiency is improved.

Optionally, in an exemplary implementation, step 301 includes: The transmit end layers the original information in descending order or ascending order of importance of information in the original information, to obtain the N layers of first bit sequences. More important information in the original information exerts a greater impact on restoring a video, an instruction, a voice, an image, a text, or the like corresponding to the original information.

Specifically, the transmit end may layer the original information by using a bit-plane layering technology, to obtain the N layers of first bit sequences, or may divide the original information into the N layers of first bit sequences by using a video coding technology such as source coding (for example, scalable video coding (SVC) or tile-based 360° layering) or another manner.

In an exemplary implementation, step 302 may be implemented in Manner 1.1 or Manner 1.2.

### Manner 1.1

In Manner 1.1, the first processing includes channel coding and bit clipping. In this case, in an exemplary implementation, step 302 includes the following steps.

302-1a: The transmit end performs channel coding on a layer-n first bit sequence in the N layers of first bit sequences, to obtain a layer-n second bit sequence, where n=1, 2, . . . , and N.

A channel coding manner may be any channel coding manner other than rateless coding. Channel coding manners used for different layers of first bit sequences may be the same or may be different. This is not specifically limited in this embodiment of this application.

302-1b: The transmit end performs bit clipping on the layer-n second bit sequence, to obtain a layer-n third bit sequence, where the layer-n third bit sequence is a part of the layer-n second bit sequence other than some or all bits in the layer-n first bit sequence.

One second bit sequence includes a corresponding first bit sequence (namely, an information bit) and a redundant bit. When bit clipping is performed, some or all bits in the first bit sequence in the second bit sequence may be clipped. The some bits may be high-order bits in the first bit sequence, may be low-order bits, or may be bits on an intermediate location. This is not specifically limited in this embodiment of this application.

For example, if a first bit sequence is 1111, a second bit sequence obtained after channel coding is performed on the first bit sequence is 11110010, first four bits in 11110010 are information bits, and last four bits are redundant bits. It is assumed that all the bits in the first bit sequence in the second bit sequence are clipped during bit clipping. A third bit sequence obtained after the first four bits in 11110010 are clipped is 0010.

At the receive end, a step corresponding to step 302 is step 308. In Manner 1.1, the fourth processing includes soft information splicing and channel decoding. In an exemplary implementation, step 308 includes steps 308-1a to 308-1c.

308-1a: The receive end performs soft information calculation based on the coding information, to obtain a log-likelihood ratio sequentially corresponding to a bit that is in the layer-n first bit sequence in the N layers of first bit sequences and that is clipped in a bit clipping process, where n=1, 2, . . . , and N.

When soft information calculation is performed based on the coding information, obtained log-likelihood ratios corresponding to all bits in the layer-n first bit sequence are the same. For example, if a proportion of 0 in one layer of first bit sequences is ¾, a log-likelihood ratio that corresponds to each bit in the layer of first bit sequences and that is calculated based on the coding information is ln((¼)/(¾))=ln(⅓).

308-1b: The receive end performs soft information splicing on the log-likelihood ratio sequentially corresponding to the bit that is in the layer-n first bit sequence and that is clipped in the bit clipping process and a log-likelihood ratio in the n^{th} layer of soft information in the first soft information, to obtain a soft information sequence corresponding to the layer-n second bit sequence, where the soft information sequence corresponding to the layer-n second bit sequence includes a log-likelihood ratio sequentially corresponding to a bit in the layer-n second bit sequence, and the log-likelihood ratio in the n^{th} layer of soft information is a log-likelihood ratio corresponding to a bit in the layer-n third bit sequence in N layers of third bit sequences.

For a method for obtaining the first soft information, refer to the following context.

In an exemplary implementation of step 308-1b, if a clipped bit is one or more most significant bits in the first bit sequence, the log-likelihood ratio sequentially corresponding to the bit that is in the layer-n first bit sequence and that is clipped in the bit clipping process is located before the log-likelihood ratio in the n^{th} layer of soft information in the first soft information in the soft information sequence corresponding to the layer-n second bit sequence. For example, if log-likelihood ratios corresponding to bits clipped from the layer-n first bit sequence in the bit clipping process are sequentially L1 and L2, and log-likelihood ratios included in the n^{th} layer of soft information in the first soft information are sequentially L3, L4, L5, and L6, the soft information sequence corresponding to the layer-n second bit sequence includes L1-L2-L3-L4-L5-L6.

308-1c: The receive end performs channel decoding on a soft information sequence corresponding to each of N layers of second bit sequences, to obtain the second soft information, where the second soft information includes a log-likelihood ratio corresponding to a bit in each of the N layers of first bit sequences.

The log-likelihood ratio corresponding to the bit in the layer-n first bit sequence may be obtained by performing channel decoding on the soft information sequence corresponding to the layer-n second bit sequence.

In an exemplary implementation of steps 308-1c, the receive end performs channel decoding by using a channel decoding manner corresponding to the channel coding manner used by the transmit end.

In Manner 1.1, in an exemplary implementation of step 308, the receive end needs to learn of a specific bit that is clipped by the transmit end during bit clipping, to perform soft information splicing, and further needs to learn of a coding rate of channel coding (or a quantity of bits in the first bit sequence and a code length), to perform channel decoding. Information such as the specific bit that is clipped by the transmit end during bit clipping and the coding rate of channel coding (or a quantity of bits in the first bit sequence and a code length) may be sent by the transmit end to the receive end, may be preconfigured or predefined at the receive end, may be partially sent by the transmit end to the receive end, or may be partially preconfigured or predefined at the receive end.

### Manner 1.2

The first processing is rateless coding. In this case, in an exemplary implementation, step 302 includes steps 302-2a:

302-2a: The transmit end performs rateless coding on a layer-n first bit sequence in the N layers of first bit sequences, to obtain a layer-n third bit sequence, where n=1, 2, . . . , and N.

In a rateless coding process, the transmit end clips off an information bit, and retains only a redundant bit.

At the receive end, a step corresponding to step 302 is step 308. In Manner 1.2, in an exemplary implementation, step 308 includes steps 308-2a and 308-2b.

308-2a: The receive end performs soft information calculation based on the coding information, to obtain a log-likelihood ratio sequentially corresponding to a bit in the layer-n first bit sequence in the N layers of first bit sequences, where n=1, 2, . . . , and N.

For a method for calculating the log-likelihood ratio corresponding to the bit in the first bit sequence, refer to related descriptions of step 308-1a. Details are not described herein again.

308-2b: The receive end performs rateless decoding on the first soft information based on the log-likelihood ratio that sequentially corresponds to the bit in each of the N layers of first bit sequences and that is obtained through soft information calculation, to obtain the second soft information, where the second soft information includes the log-likelihood ratio corresponding to the bit in each of the N layers of first bit sequences.

In a rateless decoding process, the receive end performs soft information splicing on the log-likelihood ratio that sequentially corresponds to the bit in the layer-n first bit sequence in the N layers of first bit sequences and that is obtained through soft information calculation and a log-likelihood ratio included in the n^{th} layer of soft information in the first soft information, and the log-likelihood ratio in the n^{th} layer of soft information is a log-likelihood ratio corresponding to a bit in the layer-n third bit sequence in the N layers of third bit sequences. For example, if log-likelihood ratios that correspond to bits in the layer-n first bit sequence and that are obtained through soft information calculation are sequentially L1, L2, L3, and L4, and log-likelihood ratios included in the n^{th} layer of soft information in the first soft information are sequentially L5 and L6. For the layer-n first bit sequence, a soft information sequence obtained after soft information splicing includes L1-L2-L3-L4-L5-L6.

In Manner 1.2, in an exemplary implementation of step 308, the receive end needs to learn of a coding rate of channel coding (or a quantity of bits in the first bit sequence and a code length), to perform rateless decoding. Information such as the coding rate at which the transmit end performs channel coding (or the quantity of bits in the first bit sequence and the code length) may be sent by the transmit end to the receive end, may be preconfigured or predefined at the receive end, may be partially sent by the transmit end to the receive end, or may be partially preconfigured or predefined at the receive end.

In Manner 1.1 and Manner 1.2, it may be understood that the N layers of third bit sequences are the first information. In Manner 1.1 and Manner 1.2, the original information may be compressed through bit clipping or rateless coding, to reduce a transmission resource requirement of a system.

In Manner 1.1 and Manner 1.2, optionally, a channel coding manner with a lower coding rate and/or a longer code length is used for a more important first bit sequence in the N layers of first bit sequences, or a channel coding manner with a lower coding rate and/or a longer code length is used for a first bit sequence at a higher level in the N layers of first bit sequences, the first bit sequence at a higher level is more important, and one level includes one or more first bit sequences. In this optional method, because there are more redundant bits in a sequence obtained after channel coding is performed in the channel coding manner with a lower coding rate and/or a longer code length, the channel coding manner with a lower coding code rate and/or a longer code length is more reliable, so that a probability that the receive end correctly decodes more important information can be increased, data transmission reliability can be improved, and a channel adaptation capability of data can be improved. In addition, in comparison with a case in which a very reliable channel coding manner is used for the N layers of first bit sequences, channel coding efficiency can be further improved.

The video data is used as an example. A more important bit is more critical to restoration of the video data. Provided that the receive end can accurately receive this part of information, basic image quality and a viewing feeling can be ensured. Regardless of a signal-to-noise ratio (SNR), a more important bit corresponds to more critical information in the video data. Because there is a more reliable channel coding manner, this part of information can be restored very well regardless of whether channel quality is good. A bit of unimportance is insensitive to a human eye. When there is good channel quality and a high SNR, the receive end can restore this part of information with high quality, to improve image quality. When there is poor channel quality and a low SNR, if the receive end cannot restore this part of information, the image quality is not affected greatly. Therefore, a more reliable channel coding manner is used for a more important first bit sequence, so that a channel adaptation capability of video data can be increased, a waste of a channel resource can be avoided, and implementation complexity can be simplified. In addition, during transmission of the video data, if a video rate does not match a channel capacity, when channel noise is greater than a predicted value, video reconstruction distortion is very large, or when channel noise is smaller than a predicted value, video reconstruction distortion does not decrease. This phenomenon may be referred to as a cliff effect. In this optional method, because the video data has a strong channel adaptation capability, the cliff effect can be avoided, a delay required for retransmission and a feedback can be reduced, and a low-latency video transmission requirement is met.

For example, if N=3, three layers of first bit sequences are sequentially 11111111, 00110111, and 01001000 in descending order of importance, and coding rates corresponding to the three layers of first bit sequences are sequentially ½, 4/7, and ⅔. Referring to Table 1, three layers of second bit sequences are sequentially 1111111110101100, 00110111101000, and 001101111100, and three layers of third bit sequences obtained through bit clipping are sequentially 10101100, 101000, 1100.

TABLE 1

| First bit sequences | | Second bit sequences | | Third bit sequences | |
|---|---|---|---|---|---|
| Layer 1 | 11111111 | Layer 1 | 1111111110101100 | Layer 1 | 10101100 |
| Layer 2 | 00110111 | Layer 2 | 00110111101000 | Layer 2 | 101000 |
| Layer 3 | 01001000 | Layer 3 | 001101111100 | Layer 3 | 1100 |

Optionally, a coding rate used for the coding information of the N layers of first bit sequences is lower than a coding rate used for any layer of first bit sequences in the N layers of first bit sequences, and/or a code length used for the coding information of the N layers of first bit sequences is longer than a code length used for any layer of first bit sequences in the N layers of first bit sequences. According to the optional method, it can be ensured that the receive end correctly decodes the coding information of the N layers of first bit sequences, to ensure that the original information is better restored. Certainly, the coding rate and/or the code length used for the coding information of the N layers of first bit sequences may alternatively be the same as those of a specific first bit sequence or different from those of any first bit sequence, provided that reliability of the channel coding manner is high, and it is ensured that the receive end can correctly perform decoding.

In an exemplary implementation, step 303 may be implemented in any one of Manner 2.1 to Manner 2.3.

### Manner 2.1

The second processing includes bit splicing and constellation modulation. In this case, in an exemplary implementation, step 303 includes step 303-1a and step 303-1b.

303-1a: The transmit end performs bit splicing on the N layers of third bit sequences, to obtain one layer of fourth bit sequences.

In an exemplary implementation of step 303-1a, the N layers of third bit sequences may be sequentially spliced in descending order or ascending order of importance. It should be noted that, a third bit sequence corresponding to a more important first bit sequence in the N layers of third bit sequences is more important. For example, referring to Table 1, if the three layers of first bit sequences are sequentially the layer-1 first bit sequence, the layer-2 first bit sequence, and the layer-3 first bit sequence in descending order of importance, and the three layers of third bit sequences are sequentially the layer-1 third bit sequence, the layer-2 third bit sequence, and the layer-3 third bit sequence in descending order of importance.

In addition, in a third bit sequence, a higher-order bit is more important.

For example, referring to Table 1, if the three layers of first bit sequences are sequentially the layer-1 first bit sequence, the layer-2 first bit sequence, and the layer-3 first bit sequence in descending order of importance, the fourth bit sequence obtained by performing, by the transmit end, bit splicing on the N layers of third bit sequences in descending order of importance is 101011001010001100.

303-1b: The transmit end performs constellation modulation on the fourth bit sequence, to obtain the second information.

Optionally, during constellation modulation, a more important bit in the fourth bit sequence is mapped onto a higher-order bit of a constellation symbol. A higher-order bit of the constellation symbol has higher energy. Therefore, according to this optional method, a probability that the receive end decodes more important information can be increased, to ensure transmission reliability of important data, and improve a channel adaptation capability of data. For example, it is assumed that the fourth bit sequence is 1010110010100011, and there are 16 bits in total. If 256QAM is used to perform constellation modulation, the fourth bit sequence may be mapped onto two constellation symbols. A bit on an odd-number location may be mapped onto the first constellation symbol, and a bit on an even-number location may be mapped onto the second constellation symbol. If a quantity of bits in the fourth bit sequence is insufficient to be mapped onto an integral quantity of constellation symbols (in other words, the quantity of bits in the fourth bit sequence is not an integral multiple of a quantity of bits included in the constellation symbol), the transmit end may pad the fourth bit sequence with zero, so that a quantity of bits in a fourth bit sequence obtained after zero is padded with can be mapped onto an integral quantity of constellation symbols. The fourth bit sequence obtained after zero is padded with is mapped onto the constellation symbols. Correspondingly, when performing processing, the receive end may remove, from soft information obtained after constellation demodulation, a log-likelihood ratio corresponding to 0 that is padded with.

At the receive end, a step corresponding to step 303 is step 307. In Manner 2.1, the third processing includes constellation demodulation and soft information splitting. In this case, in an exemplary implementation, step 307 may include step 307-1a and step 307-1b.

307-1a: The receive end performs constellation demodulation on the second information, to obtain third soft information, where the third soft information is a log-likelihood ratio corresponding to each bit in the fourth bit sequence, the fourth bit sequence is obtained by performing bit splicing on the N layers of third bit sequences by the transmit end, and the N layers of third bit sequences are the first information.

307-1b: The receive end performs soft information splitting on the third soft information, to obtain the first soft information, where the first soft information includes N layers of soft information, and one layer of soft information is a log-likelihood ratio corresponding to a bit in one of the N layers of third bit sequences.

To perform soft information splitting, the receive end needs to learn of a value of N and a quantity of bits included in each third bit sequence. The value of N and the quantity of bits included in each third bit sequence may be sent by the transmit end to the receive end, may be preconfigured or predefined at the receive end, may be partially sent by the transmit end to the receive end, or may be partially preconfigured or predefined at the receive end. The quantity of bits included in each third bit sequence may alternatively be determined by the receive end based on one or more of a quantity of bits in each first bit sequence, a coding rate or a code length of each first bit sequence, and a quantity of bits clipped from each first bit sequence. Information such as the quantity of bits in each first bit sequence, the coding rate or the code length of each first bit sequence, and the quantity of bits clipped from each first bit sequence may be sent by the transmit end to the receive end, may be preconfigured or predefined at the receive end, may be partially sent by the transmit end to the receive end, or may be partially preconfigured or predefined at the receive end.

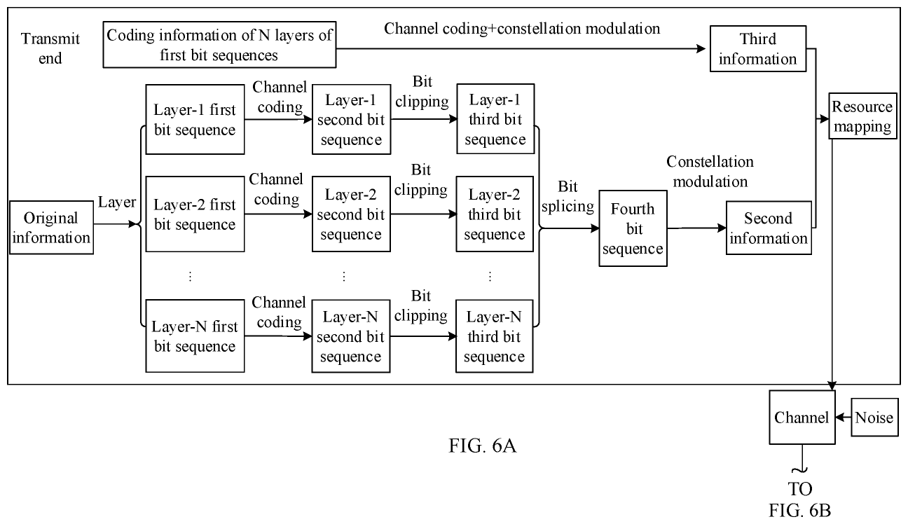

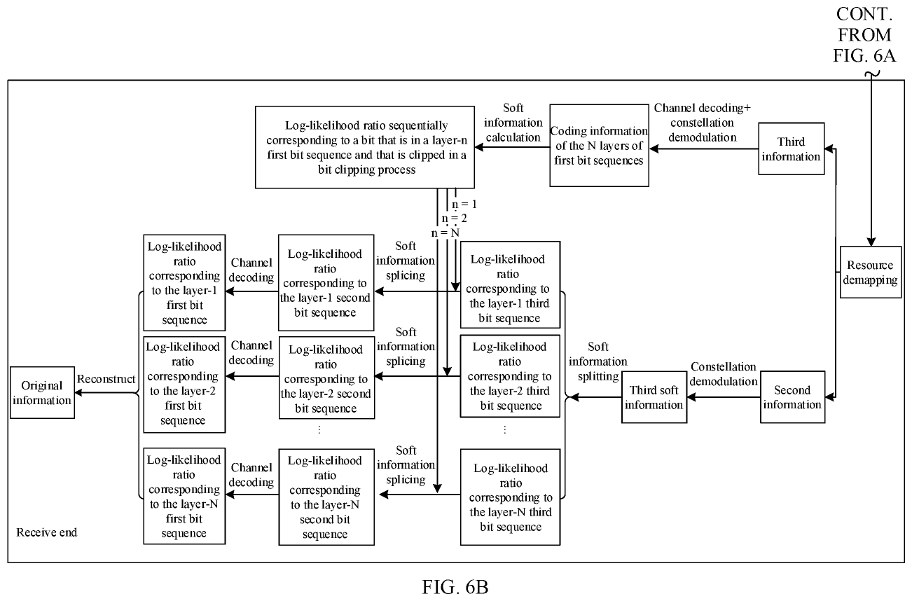

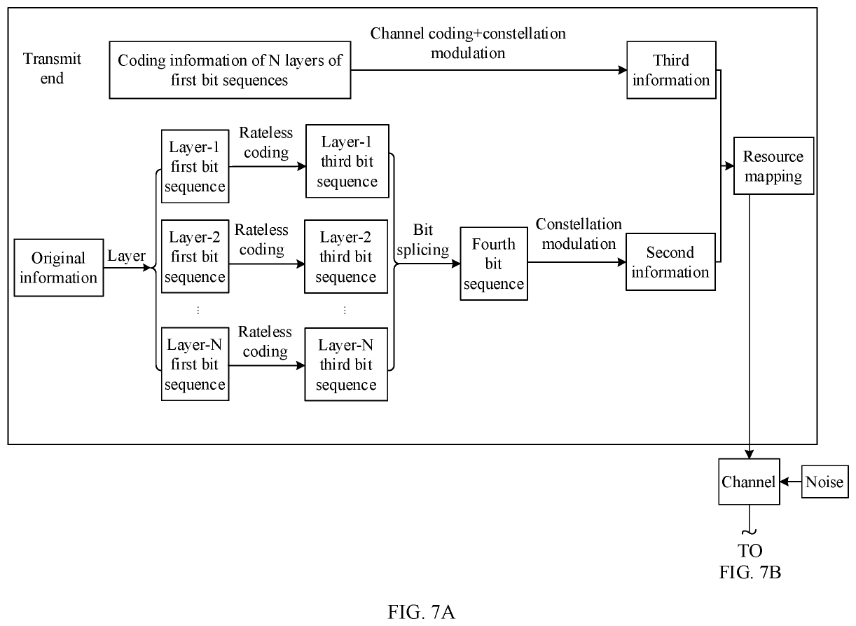

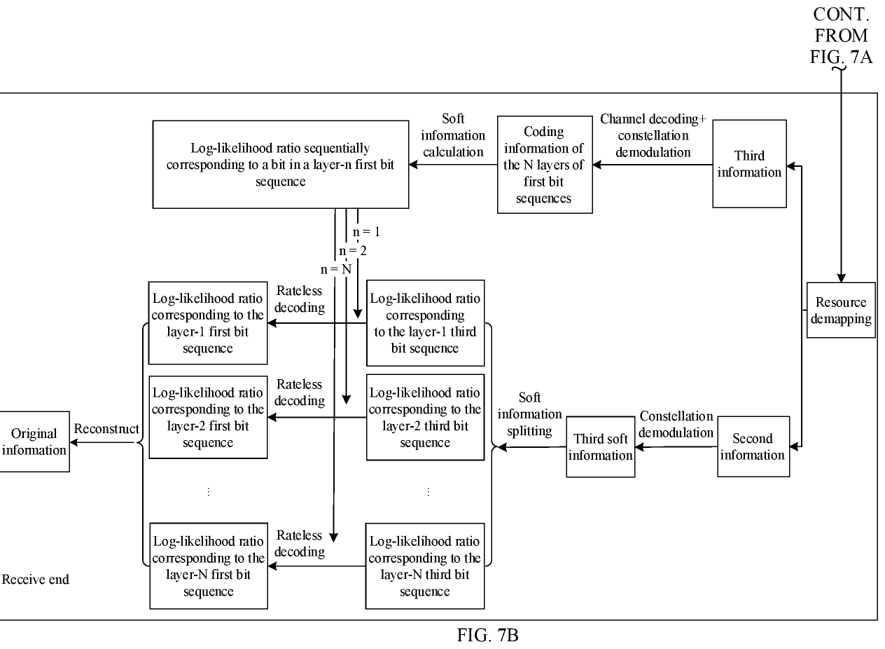

In Manner 2.1, if step 302 is implemented in Manner 1.1, for data processing processes of the transmit end and the receive end, refer to FIG. 6A and FIG. 6B. If step 302 is implemented in Manner 1.2, for data processing processes of the transmit end and the receive end, refer to FIG. 7A and FIG. 7B.

### Manner 2.2

The second processing includes bit splicing, constellation modulation, and constellation symbol splicing. In this case, in an exemplary implementation, step 303 includes step 303-2a to step 303-2c.

303-2a: The transmit end performs bit splicing on N layers of third bit sequences, to obtain M layers of fourth bit sequences, where a layer-m fourth bit sequence in the M layers of fourth bit sequences includes the m^{th} bit in all third bit sequences that are in the N layers of third bit sequences and that include the m^{th} bit, M is an integer greater than 1, and m is an integer greater than 0 and less than or equal to M.

A higher-order bit in the layer-m fourth bit sequence belongs to a more important third bit sequence.

It can be understood that a value of M is a quantity of bits in a third bit sequence that includes a largest quantity of bits in the N layers of third bit sequences. For example, based on the example shown in Table 1, the value of M is 8. Based on the example shown in Table 1, for eight layers of fourth bit sequences obtained after bit splicing is performed on the three layers of third bit sequences, refer to Table 2.

TABLE 2
Fourth bit sequences

| | |
|---|---|
| Layer 1 | 111 |
| Layer 2 | 001 |
| Layer 3 | 110 |
| Layer 4 | 000 |
| Layer 5 | 10 |
| Layer 6 | 10 |
| Layer 7 | 0 |
| Layer 8 | 0 |

303-2b: The transmit end separately performs constellation modulation on the M layers of fourth bit sequences, to obtain M layers of constellation symbol sequences.

Optionally, a modulation mode with a lower modulation order is used for a more important fourth bit sequence in the M layers of fourth bit sequences, or a modulation mode with a lower modulation order is used for a fourth bit sequence at a higher level in the M layers of fourth bit sequences, the fourth bit sequence at a higher level is more important, and one level includes one or more fourth bit sequences. According to the optional method, a more reliable constellation modulation mode may be used for more important information, to improve a probability that the receive end correctly demodulates important information, and improve data transmission reliability.

For example, based on the example shown in Table 2, in a possible implementation, modulation orders used for the layer-1 fourth bit sequence to the layer-8 fourth bit sequence sequentially decrease. In another possible implementation, the layer-1 fourth bit sequence to the layer-4 fourth bit sequence may be at a first level, the layer-5 fourth bit sequence and the layer-6 fourth bit sequence may be at a second level, and the layer-7 fourth bit sequence and the layer-8 fourth bit sequence may be at a third level. A same modulation order is used for fourth bit sequences at a same level, and modulation orders used for the fourth bit sequences at the first level, the second level, and the third level sequentially decrease.

It should be noted that if a quantity of bits in the fourth bit sequence is insufficient to be mapped onto an integral quantity of constellation symbols, the transmit end may pad the fourth bit sequence with zero, so that a quantity of bits in a fourth bit sequence obtained after zero is padded with can be mapped onto the integral quantity of constellation symbols. The fourth bit sequence obtained after zero is padded with is mapped onto the constellation symbol. Correspondingly, when performing processing, the receive end may remove, from soft information obtained after constellation demodulation, a log-likelihood ratio corresponding to 0 that is padded with.

By using steps 303-2a and 303-2b, a more important third bit sequence may be mapped onto a higher-order bit of the constellation symbol. A higher-order bit of the constellation symbol has higher energy. Therefore, according to the method, a probability that the receive end decodes more important information can be increased, to ensure transmission reliability of important data, and improve a channel adaptation capability of data.

303-2c: The transmit end performs constellation symbol splicing on the M layers of constellation symbol sequences, to obtain the second information.

In an exemplary implementation of step 303-2c, the M layers of constellation symbol sequences may be sequentially spliced in a sequence of a layer-1 constellation symbol sequence to a layer-M constellation symbol sequence, or may be sequentially spliced in a sequence of a layer-M constellation symbol sequence to a layer-1 constellation symbol sequence. This is not specifically limited in this embodiment of this application.

In Manner 2.2, correspondingly, the third processing includes constellation symbol splitting, constellation demodulation, and soft information splitting. In this case, in an exemplary implementation, step 307 may include step 307-2a to step 307-2c.

307-2a: The receive end performs constellation symbol splitting on the second information, to obtain the M layers of constellation symbol sequences.

307-2b: The receive end separately performs constellation demodulation on the M layers of constellation symbol sequences, to obtain M layers of third soft information, where the M layers of third soft information each are a log-likelihood ratio corresponding to a bit in the M layers of fourth bit sequences.

307-2c: The receive end performs soft information splitting on the M layers of third soft information, to obtain first soft information, where the first soft information includes N layers of soft information, and one layer of soft information is a log-likelihood ratio corresponding to a bit in one of the N layers of third bit sequences.

To perform constellation symbol splitting, the receive end needs to learn of the value of M and a quantity of constellation symbols included in each constellation symbol sequence. To perform soft information splitting, the receive end needs to learn of a bit splicing manner of the transmit end. Information such as the value of M, the quantity of constellation symbols included in each constellation symbol sequence, and the bit splicing manner of the transmit end may be sent by the transmit end to the receive end, may be preconfigured or predefined at the receive end, may be partially sent by the transmit end to the receive end, or may be partially preconfigured or predefined at the receive end.

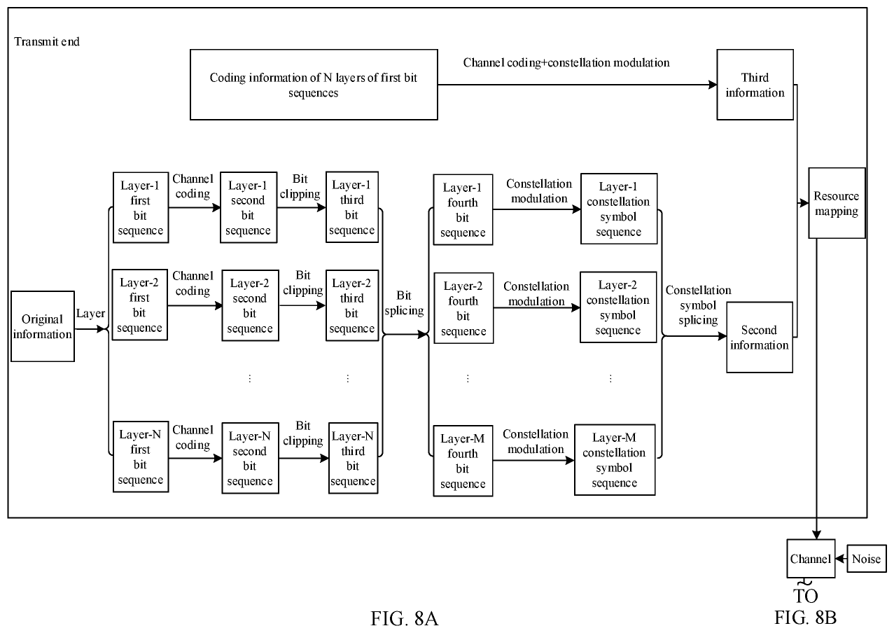

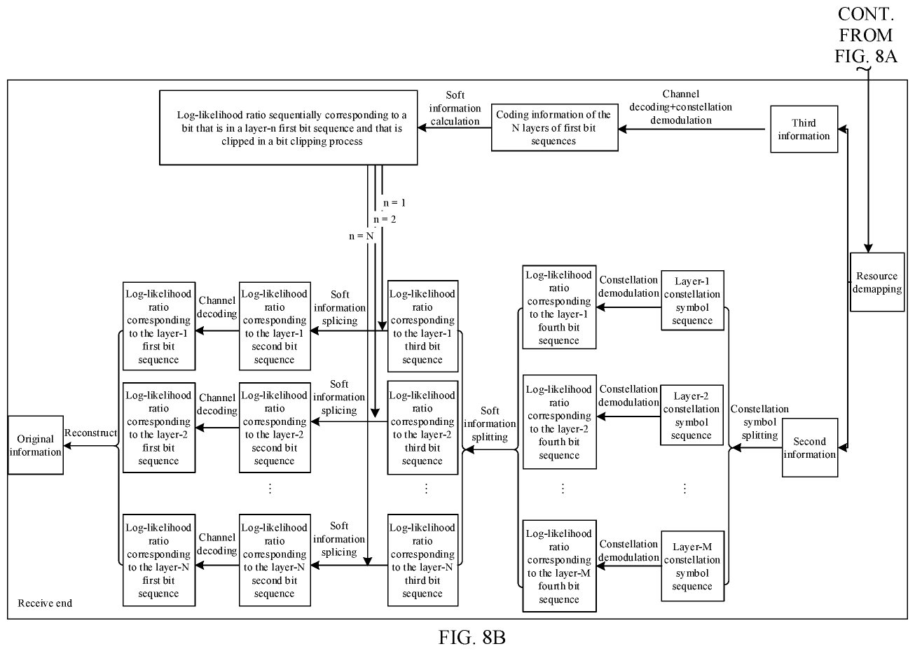

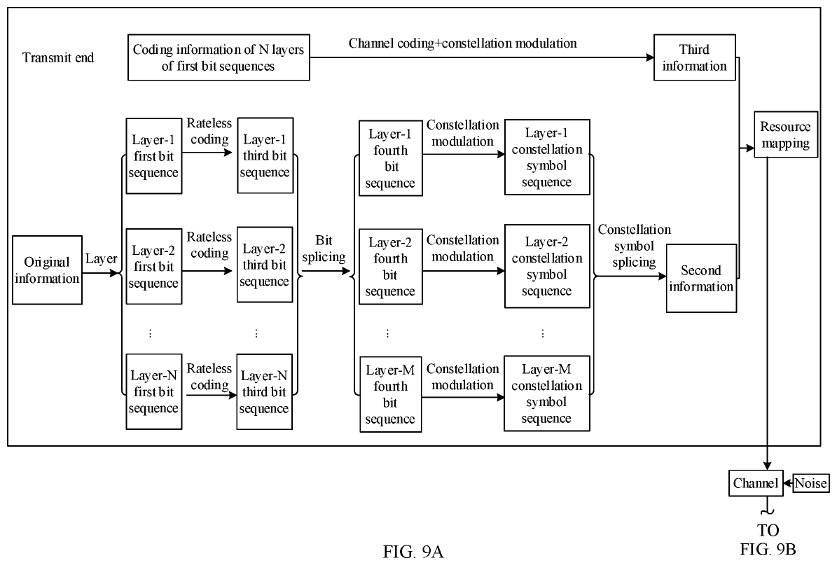

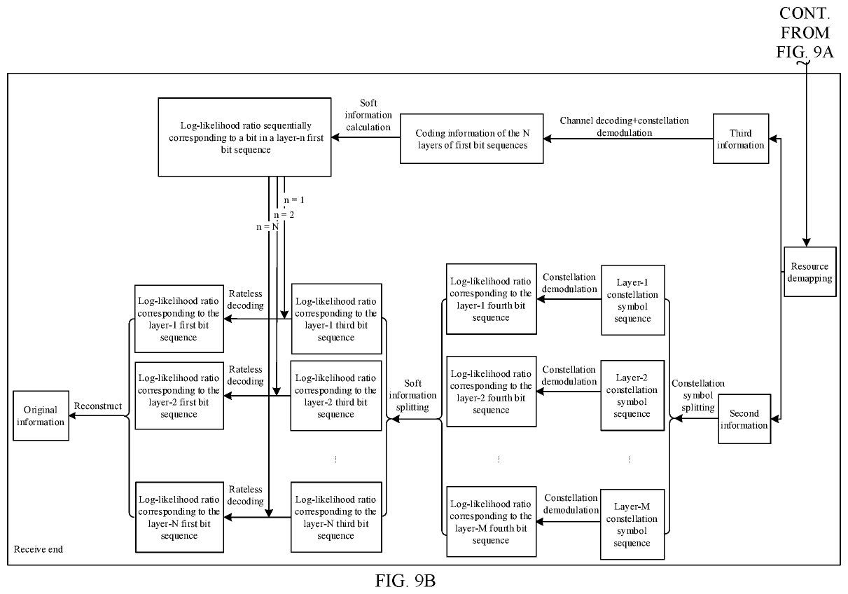

In Manner 2.2, if step 302 is implemented in Manner 1.1, for data processing processes of the transmit end and the receive end, refer to FIG. 8A and FIG. 8B. If step 302 is implemented in Manner 1.2, for data processing processes of the transmit end and the receive end, refer to FIG. 9A and FIG. 9B.

### Manner 2.3

The second processing includes constellation modulation and constellation symbol splicing. In this case, in an exemplary implementation, step 303 includes the following steps.

303-3a: The transmit end separately performs constellation modulation on N layers of third bit sequences, to obtain N layers of constellation symbol sequences.

It should be noted that if a quantity of bits in the third bit sequence is insufficient to be mapped onto an integral quantity of constellation symbols, the transmit end may pad the third bit sequence with zero, so that a quantity of bits in a third bit sequence obtained after zero is padded with can be mapped onto the integral quantity of constellation symbols. The third bit sequence obtained after zero is padded with is mapped onto the constellation symbol. Correspondingly, when performing processing, the receive end may remove, from soft information obtained after constellation demodulation, a log-likelihood ratio corresponding to 0 that is padded with.

Optionally, a modulation mode with a lower modulation order is used for a more important third bit sequence in the N layers of third bit sequences, or a modulation mode with a lower modulation order is used for a third bit sequence at a higher level in the N layers of third bit sequences, the third bit sequence at a higher level is more important, and one level includes one or more third bit sequences. According to the optional method, a more reliable constellation modulation mode may be used for more important information, to improve a probability that the receive end correctly demodulates important information, and improve data transmission reliability.

For example, based on the example shown in Table 1, in a possible implementation, modulation orders used for the layer-1 third bit sequence to the layer-3 third bit sequence sequentially decrease. In another possible implementation, the layer-1 third bit sequence may be at a first level, and the layer-2 third bit sequence and the layer-3 third bit sequence may be at a second level. A same modulation order is used for third bit sequences at a same level, and modulation orders used for the third bit sequences at the first level and the second level sequentially decrease.

Optionally, a more important bit in each of the N layers of third bit sequences is mapped onto a higher-order bit of a constellation symbol in a corresponding constellation symbol sequence. A higher-order bit of the constellation symbol has higher energy. Therefore, according to this optional method, a probability that the receive end decodes more important information can be increased, to ensure transmission reliability of important data, and improve a channel adaptation capability of data.

303-3b: The transmit end performs constellation symbol splicing on the N layers of constellation symbol sequences, to obtain the second information.

In an exemplary implementation of step 303-3b, the N layers of constellation symbol sequences may be sequentially spliced in a sequence of a layer-1 constellation symbol sequence to a layer-N constellation symbol sequence, or may be sequentially spliced in a sequence of a layer-N constellation symbol sequence to a layer-1 constellation symbol sequence. This is not specifically limited in this embodiment of this application.

In Manner 2.3, correspondingly, the third processing includes constellation symbol splitting and constellation demodulation. In this case, in an exemplary implementation, step 307 may include step 307-3a and step 307-3b.

307-3a: The receive end performs constellation symbol splitting on the second information, to obtain the N layers of constellation symbol sequences.

307-3b: The receive end separately performs constellation demodulation on the N layers of constellation symbol sequences, to obtain first soft information, where the first soft information includes N layers of soft information, and one layer of soft information is a log-likelihood ratio corresponding to a bit in one of the N layers of third bit sequences.

To perform constellation symbol splitting, the receive end needs to learn of a value of N and a quantity of constellation symbols included in each constellation symbol sequence. To perform constellation demodulation, the receive end needs to learn of a modulation order of each third bit sequence. Information such as the value of N, the quantity of constellation symbols included in each constellation symbol sequence, and the modulation order of each third bit sequence may be sent by the transmit end to the receive end, may be preconfigured or predefined at the receive end, may be partially sent by the transmit end to the receive end, or may be partially preconfigured or predefined at the receive end.

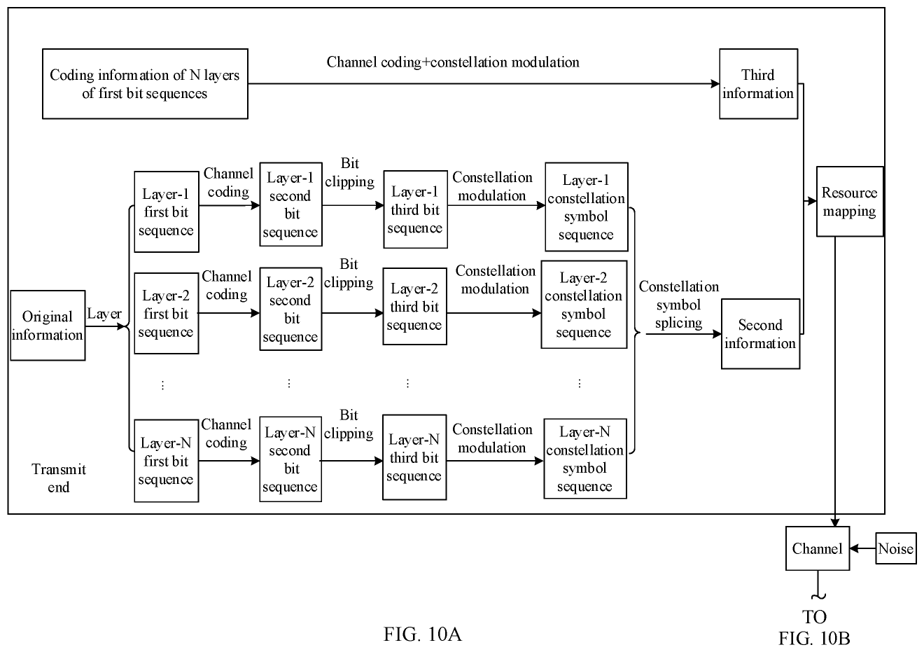

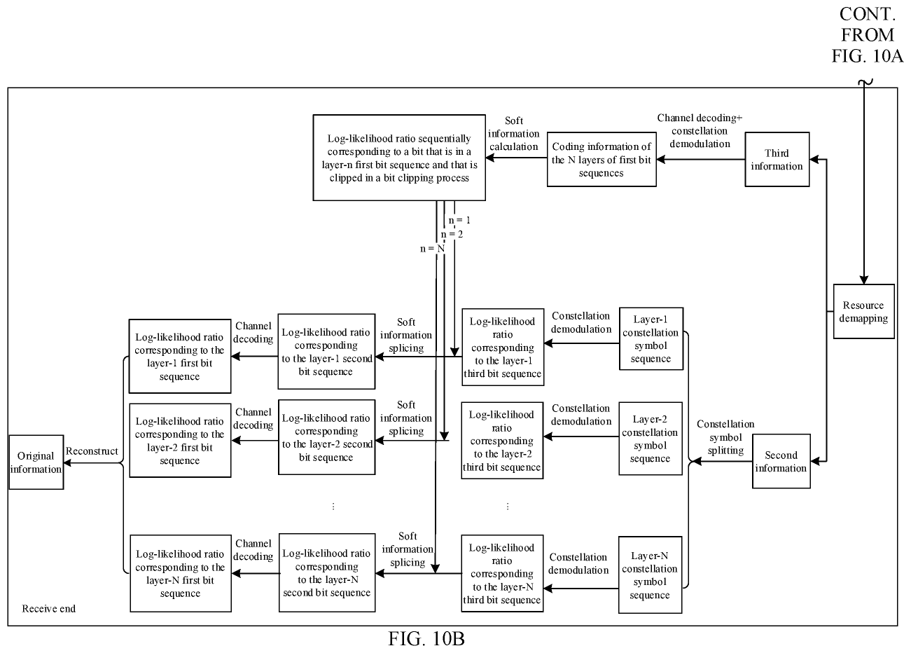

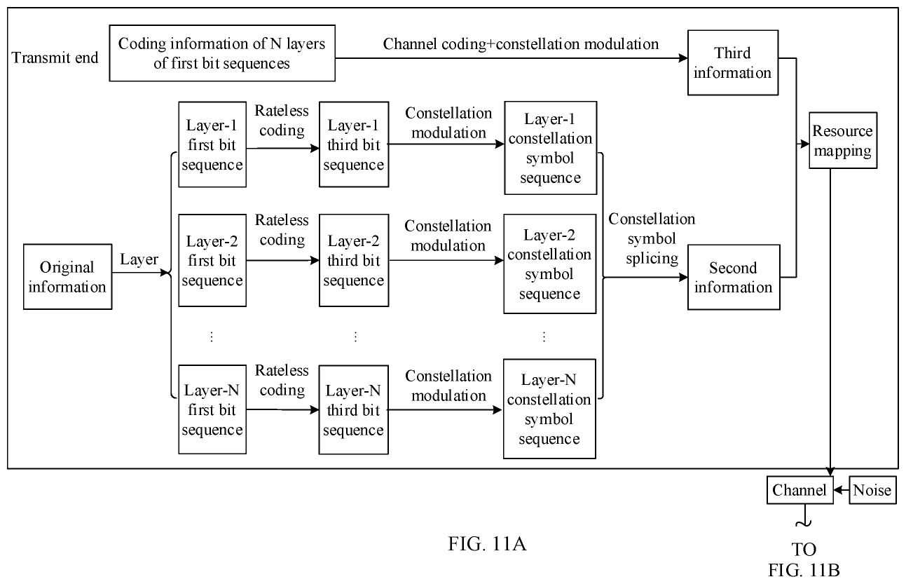

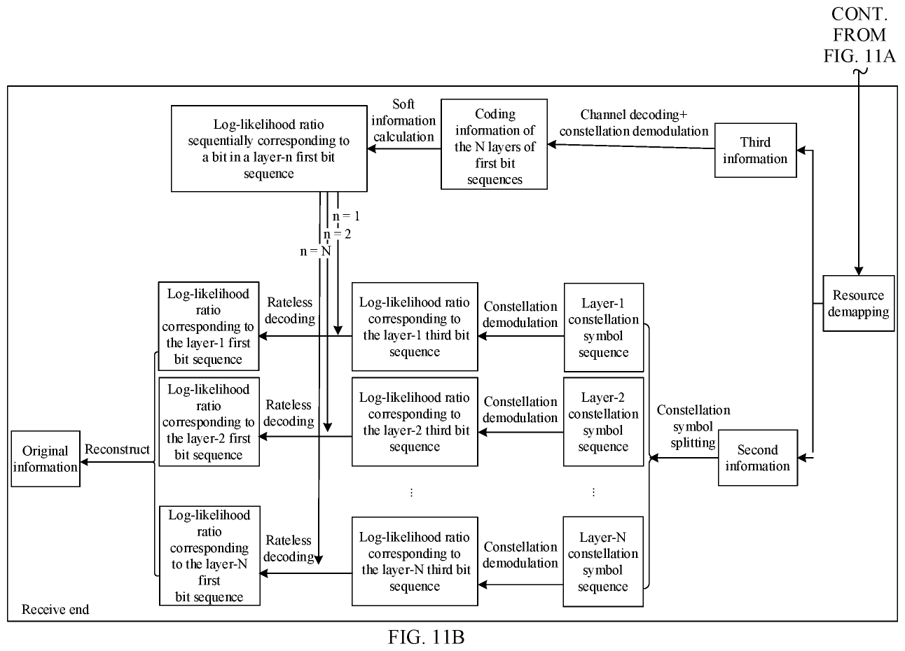

In Manner 2.3, if step 302 is implemented in Manner 1.1, for data processing processes of the transmit end and the receive end, refer to FIG. 10A and FIG. 10B. If step 302 is implemented in Manner 1.2, for data processing processes of the transmit end and the receive end, refer to FIG. 11A and FIG. 11B.

In an exemplary implementation, step 309 may be implemented in Manner 3.1 or Manner 3.2.

### Manner 3.1. Soft Reconstruction

The receive end may perform channel decoding in a confidence transmission method (a proportion of 0 or 1 in the N layers of first bit sequences in the coding information is used as an initial iteration value), to obtain a probability that each bit in each layer of first bit sequences is 0 or 1, and perform information combination based on the probability, to restore the original information. The original information is one or more integers.

A value in the original information is

$$x = {\sum }_{i = 1}^{I} ( {p}_{i} ( 1 ) \times {2}^{I - i} + {p}_{i} ( 0 ) \times 0 ) = {\sum }_{i = 1}^{I} ( {p}_{i} ( 1 ) \times {2}^{I - i} ) ,$$

where I represents a quantity of bits of the value in binary conversion, and pᵢ(b) represents a probability that the i^{th} bit in a first bit sequence corresponding to the value is b (b=0 or 1).

Manner 3.2: Hard Reconstruction (Which may be Implemented Through a Hard Decision)

The receive end may obtain a value of each bit in the original information based on a hard decision of a probability that each bit in each layer of first bit sequences is 0 or 1. In this case, the original information is one or more bit sequences.

Optionally, to improve system robustness and image quality, the transmit end may map, onto different frequency domain resources based on a frequency selection characteristic and a spatial propagation characteristic of a channel, a constellation symbol obtained after constellation modulation (for example, a resource block (RB)) and a spatial domain resource (for example, an antenna port). For example, an important constellation symbol may be mapped onto a subcarrier or an antenna port with a large channel gain.

Currently, there are four common video data processing methods. Method 1 and Method 2 are digital-analog hybrid video data processing methods, and Method 3 and Method 4 are pure digital video data processing methods.

### Method 1: SoftCast

A processing process of SoftCast includes: performing DCT transformation, power allocation, whitening, and resource mapping on an image, and sending the image, where the receive end performs linear least square estimate (LLSE) decoding and DCT inverse transformation on a received signal, to obtain the image.

Because channel coding is not used for SoftCast, information is directly transmitted on a channel, and is greatly affected by noise. In particular, when there is a low SNR, a very poor signal is received, and visual quality of a video cannot meet an actual requirement. According to the method provided in this embodiment of this application, channel coding is performed on the N layers of first bit sequences, so that the signal is reliably transmitted on the channel.

### Method 2: Amimon's Joint Source and Channel Coding (JSCC)

A processing process of Amimon's JSCC includes: layering an image, to obtain a coarse information layer and a fine information layer, directly performing constellation modulation and resource mapping on the fine information layer, and sending a signal mapped onto a transmission resource.

Because channel coding is not performed on the fine information layer in Amimon's JSCC, information is directly transmitted on a channel, and is greatly affected by noise. In particular, when there is a low SNR, a very poor signal is received, and visual quality of a video cannot meet an actual requirement. According to the method provided in this embodiment of this application, channel coding is performed on the N layers of first bit sequences, so that the signal is reliably transmitted on the channel. In addition, according to the method provided in this embodiment of this application, data can have a strong channel adaptation capability.

Method 3: Advanced television systems committee (ATSC) layered division multiplexing (LDM) and scalable high efficiency video coding (SHVC) may be referred to as ATSC's LDM & SHVC for short.

A processing process of ATSC's LDM & SHVC includes: layering an image (into a basic layer and an enhancement layer) based on a sampling point, performing channel coding and constellation modulation on each layer, integrating information obtained after constellation modulation, and mapping the integrated information onto a transmission resource for sending.

According to the method provided in this embodiment of this application, bit clipping is performed on the N layers of second bit sequences obtained after channel coding is performed on the N layers of first bit sequences, to reduce a quantity of bits transmitted by the transmit end, and improve data transmission efficiency. In addition, in ATSC's LDM & SHVC, the image is divided into only two layers, and there is a very limited channel adaptation capability. However, in this application, the original information is divided into three layers, four layers, or even more layers based on importance, to improve a channel adaptation capability of video data.

### Method 4: FlexCast

A processing process of FlexCast includes: performing DCT transformation, binary conversion, rateless coding, and resource mapping on an image, and sending the image.

In FlexCast, when there is a large SNR change range (for example, more than 7 dB), the transmit end needs to adjust a modulation order based on channel state information such as an SNR fed back by the receive end, to improve implementation complexity of the transmit end. According to the method provided in this embodiment of this application, data is adaptive to a channel, and the modulation order does not need to be adjusted based on the channel state information such as the SNR fed back by the receive end. In comparison with FlexCast, implementation complexity of the transmit end is reduced.

The foregoing describes solutions in embodiments of this application mainly from a perspective of interaction between network elements. It may be understood that, to implement the foregoing functions, each network element, such as a transmit end apparatus or a receive end apparatus, includes a corresponding hardware structure and/or software module for performing each function. A person skilled in the art should easily be aware that in combination with the examples described in the embodiments disclosed in this specification, units, algorithm steps may be implemented by hardware or a combination of hardware and computer software in this application. Whether a function is performed by hardware or hardware driven by computer software depends on particular applications and design constraints of the respective technical solutions. A person skilled in the art may use different methods to implement the described functions for each particular application, but it should not be considered that the implementation goes beyond the scope of this application.

In embodiments of this application, the transmit end apparatus and the receive end apparatus may be divided into functional units based on the foregoing method examples. For example, each functional unit may be obtained through division based on a corresponding function, or two or more functions may be integrated into one processing unit. The integrated unit may be implemented in a form of hardware, or may be implemented in a form of a software functional unit. It should be noted that in embodiments of this application, division into the units is an example and is merely logical function division, and may be other division during actual implementation.

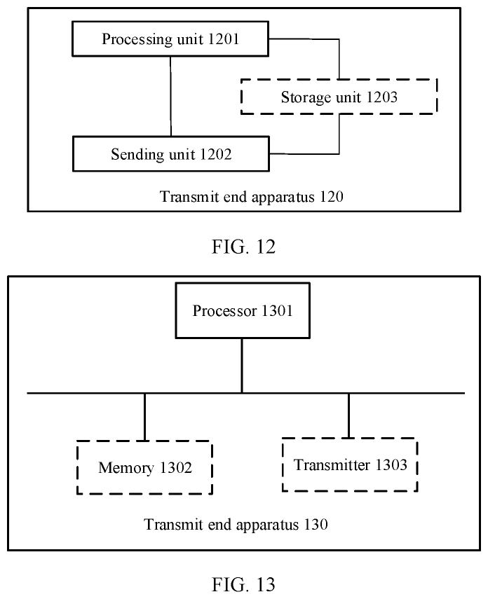

FIG. 12 is a possible schematic structural diagram of a transmit end apparatus (denoted as a transmit end apparatus 120) in the foregoing embodiments. The transmit end apparatus 120 includes a processing unit 1201 and a sending unit 1202, and may further include a storage unit 1203.

The processing unit 1201 is configured to control and manage an action of the transmit end apparatus. For example, the processing unit 1201 is configured to support the transmit end apparatus to perform step 301 to step 305 in FIG. 3, and/or an action performed by the transmit end apparatus in another process described in embodiments of this application. The processing unit 1201 may communicate with another network entity by using the sending unit 1202, for example, communicate with the receive end shown in FIG. 3. The storage unit 1203 is configured to store program code and data of the transmit end apparatus. The transmit end apparatus may be a device, or may be a chip in the device.

An antenna and a control circuit that have a sending function in the transmit end apparatus 120 may be considered as the sending unit 1202 of the transmit end apparatus 120, and a processor that has a processing function may be considered as the processing unit 1201 of the transmit end apparatus 120. The sending unit 1202 may be a transmitter, a transmitter machine, a transmitter circuit, or the like.

When the integrated unit in FIG. 12 is implemented in a form of a software functional module and sold or used as an independent product, the integrated unit may be stored in a computer-readable storage medium. Based on such an understanding, technical solutions of embodiments of this application may be implemented in a form of a software product. The computer software product is stored in a storage medium, and includes several instructions for instructing a computer device (which may be a personal computer, a server, a network device, or the like) or a processor to perform all or some of the steps of methods in embodiments of this application. The storage medium that stores the computer software product includes any medium that can store program code, for example, a USB flash drive, a removable hard disk, a read-only memory (ROM), a random access memory (RAM), a magnetic disk, or an optical disc.

The unit in FIG. 12 may also be referred to as a module. For example, the processing unit may be referred to as a processing module.

In addition, FIG. 13 is another possible schematic structural diagram of a transmit end apparatus (denoted as a transmit end apparatus 130) in the foregoing embodiments. Referring to FIG. 13, the transmit end apparatus 130 includes a processor 1301, and optionally, further includes a memory 1302 and/or a transmitter 1303 that are/is connected to the processor 1301. The processor 1301, the memory 1302, and the transceiver 1303 are connected through a bus.

The processor 1301 may be a general-purpose central processing unit (CPU), a microprocessor, an application-specific integrated circuit (ASIC), or one or more integrated circuits configured to control program execution of solutions in this application. The processor 1301 may alternatively include a plurality of CPUs, and the processor 1301 may be a single-core (single-CPU) processor or a multi-core (multi-CPU) processor. The processor herein may be one or more devices, circuits, and/or processing cores configured to process data (for example, computer program instructions).

The memory 1302 may be a ROM or another type of static storage device that can store static information and instructions, or a RAM or another type of dynamic storage device that can store information and instructions, or may be an electrically erasable programmable read-only memory (EEPROM), a compact disc read-only memory (CD-ROM) or another compact disc storage device, an optical disc storage device (including a compact disc, a laser disc, an optical disc, a digital versatile disc, a Blu-ray disc, or the like), a magnetic disk storage medium or another magnetic storage device, or any other medium that can be used to carry or store expected program code in a form of instructions or a data structure and that can be accessed by a computer. This is not limited in embodiments of this application. The memory 1302 may exist independently, or may be integrated into the processor 1301. The memory 1302 may include computer program code.

The processor 1301 is configured to execute the computer program code stored in the memory 1302, to implement a method provided in embodiments of this application. For example, the processor 1301 is configured to support the transmit end apparatus in performing step 301 to step 305 in FIG. 3, and/or an action performed by the transmit end apparatus in another process described in embodiments of this application. The processor 1301 may communicate with another network entity by using the transmitter 1303, for example, communicate with the receive end shown in FIG. 3. The memory 1302 is configured to store program code and data of the transmit end apparatus.

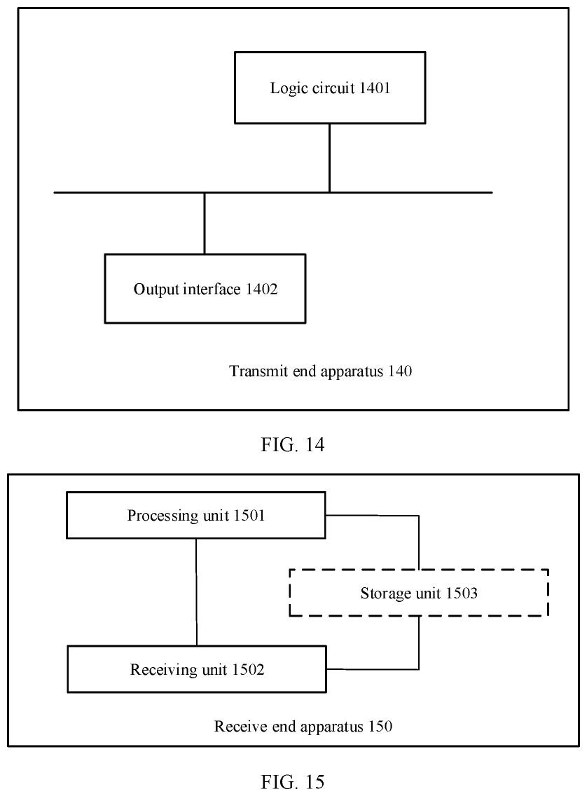

FIG. 14 is another possible schematic structural diagram of a transmit end apparatus (denoted as a transmit end apparatus 140) in the foregoing embodiments.

Refer to FIG. 14. The transmit end apparatus 140 includes a logical circuit 1401 and an output interface 1402. The logical circuit 1401 is configured to control and manage an action of the transmit end apparatus. For example, the logical circuit 1401 is configured to support the transmit end apparatus to perform step 301 to step 305 in FIG. 3, and/or an action performed by the transmit end apparatus in another process described in embodiments of this application. The logical circuit 1401 may communicate with another network entity through an output interface, for example, communicate with a receive end shown in FIG. 3.

FIG. 15 is a possible schematic structural diagram of a receive end apparatus (denoted as a receive end apparatus 150) in the foregoing embodiments. The receive end apparatus 150 includes a processing unit 1501 and a receiving unit 1502, and may further include a storage unit 1503.

The processing unit 1501 is configured to control and manage an action of the receive end apparatus. For example, the processing unit 1501 is configured to support the receive end apparatus to perform step 305 to step 309 in FIG. 3, and/or an action performed by the receive end apparatus in another process described in embodiments of this application. The processing unit 1501 may communicate with another network entity by using the receiving unit 1502, for example, communicate with the transmit end shown in FIG. 3. The storage unit 1503 is configured to store program code and data of the receive end apparatus. The receive end apparatus may be a device, or may be a chip in the device.

An antenna and a control circuit that have a receiving function in the receive end apparatus 150 may be considered as the receiving unit 1502 of the receive end apparatus 150, and a processor that has a processing function may be considered as the processing unit 1501 of the receive end apparatus 150. The receiving unit 1502 may be a receiver, a receiver machine, a receiver circuit, or the like.

When the integrated unit in FIG. 15 is implemented in a form of a software functional module and sold or used as an independent product, the integrated unit may be stored in a computer-readable storage medium. Based on such an understanding, technical solutions of embodiments of this application may be implemented in a form of a software product. The computer software product is stored in a storage medium, and includes several instructions for instructing a computer device (which may be a personal computer, a server, a network device, or the like) or a processor to perform all or some of the steps of methods in embodiments of this application. The storage medium that stores the computer software product includes any medium that can store program code, for example, a USB flash drive, a removable hard disk, a read-only memory (ROM), a random access memory (RAM), a magnetic disk, or an optical disc.

The unit in FIG. 15 may also be referred to as a module. For example, the processing unit may be referred to as a processing module.

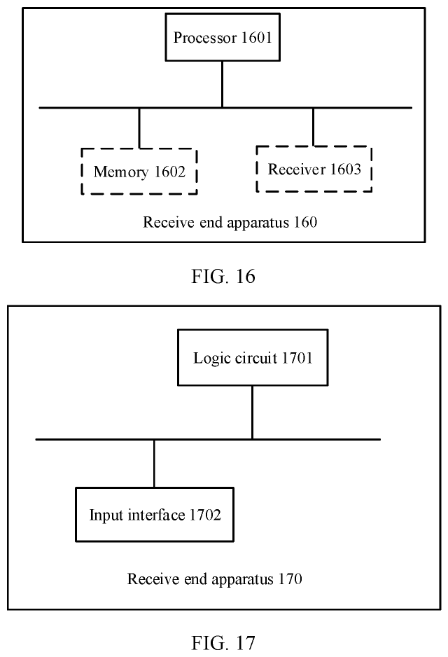

In addition, FIG. 16 is another possible schematic structural diagram of a receive end apparatus (denoted as a receive end apparatus 160) in the foregoing embodiments.

Referring to FIG. 16, the receive end apparatus 160 includes a processor 1601, and optionally, further includes a memory 1602 and/or a receiver 1603 that are connected to the processor 1601. The processor 1601, the memory 1602, and the receiver 1603 are connected through a bus.

For a description of the processor 1601, refer to the foregoing description of the processor 1301. Details are not described herein again.

For a description of the memory 1602, refer to the foregoing description of the memory 1302. Details are not described herein again.

The processor 1601 is configured to execute the computer program code stored in the memory 1602, to implement a method provided in embodiments of this application. For example, the processor 1601 is configured to support the receive end apparatus to perform step 305 to step 309 in FIG. 3, and/or an action performed by the receive end apparatus in another process described in embodiments of this application. The processor 1601 may communicate with another network entity by using the receiver 1603, for example, communicate with the transmit end shown in FIG. 3. The memory 1602 is configured to store program code and data of the receive end apparatus.

FIG. 17 is another possible schematic structural diagram of a receive end apparatus (denoted as a receive end apparatus 170) in the foregoing embodiments. Referring to FIG. 17, the receive end apparatus 170 includes a logical circuit 1701 and an input interface 1702. The logical circuit 1701 is configured to control and manage an action of the receive end apparatus. For example, the logical circuit 1701 is configured to support the receive end apparatus to perform step 305 to step 309 in FIG. 3, and/or an action performed by the receive end apparatus in another process described in embodiments of this application. The logical circuit 1701 may communicate with another network entity through an input interface, for example, communicate with a transmit end shown in FIG. 3.

An embodiment of this application further provides a computer-readable storage medium, including instructions. When the instructions are run on a computer, the computer is enabled to perform any one of the foregoing methods.

An embodiment of this application further provides a computer program product including instructions. When the computer program product runs on a computer, the computer is enabled to perform any one of the foregoing methods.

An embodiment of this application further provides a communications system, including the foregoing transmit end and the foregoing receive end.

All or some of the foregoing embodiments may be implemented by using software, hardware, firmware, or any combination thereof. When a software program is used to implement embodiments, all or some of the embodiments may be implemented in a form of a computer program product. The computer program product includes one or more computer instructions. When the computer program instructions are loaded and executed on a computer, the procedure or functions according to embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive (SSD)), or the like.

Although this application is described with reference to the foregoing disclosed embodiments, in a process of implementing this application that claims protection, a person skilled in the art may understand and implement another variation of the disclosed embodiments by viewing the accompanying drawings, disclosed content, and the appended claims. In the claims, “comprising” (comprising) does not exclude another component or another step, and “a” or “one” does not exclude a meaning of plurality. A single processor or another unit may implement several functions enumerated in the claims. Some measures are recorded in dependent claims that are different from each other, but this does not mean that these measures cannot be combined to produce a better effect.

Although this application is described with reference to exemplary features and embodiments thereof, it is clear that various modifications and combinations may be made to them without departing from the spirit and scope of this application. Correspondingly, the specification and accompanying drawings are merely example description of this application defined by the appended claims, and are considered as any of or all modifications, variations, combinations or equivalents that cover the scope of this application. A person skilled in the art can make various modifications and variations to this application without departing from the spirit and scope of this application. This application is intended to cover these modifications and variations of this application provided that the modifications and variations fall within the scope of protection defined by the following claims and their equivalent technologies.

1. A data processing method, comprising:
layering, by a transmit end, original information, to obtain N layers of first bit sequences, wherein the original information is at least one bit sequence or at least one integer, and N is an integer greater than 1;
performing, by the transmit end, first processing on the N layers of first bit sequences, to obtain first information;
performing, by the transmit end, second processing on the first information, to obtain second information;
performing, by the transmit end, channel coding and constellation modulation on coding information of the N layers of first bit sequences, to obtain third information, wherein the coding information indicates proportion information of 0 or 1 in each of the N layers of first bit sequences; and
sending, by the transmit end, the second information and the third information to a receive end.

2. The method according to claim 1, wherein layering the original information comprises:
layering, by the transmit end, the original information in descending order or ascending order of importance of information in the original information, to obtain the N layers of first bit sequences.

3. The method according to claim 1, wherein the first processing comprises channel coding and bit clipping, and wherein performing the first processing on the N layers of first bit sequences comprises:
performing, by the transmit end, channel coding on layer-n first bit sequences in the N layers of first bit sequences, to obtain layer-n second bit sequences, wherein n=1, 2, . . . , N; and
performing, by the transmit end, bit clipping on the layer-n second bit sequences, to obtain layer-n third bit sequences.

4. The method according to claim 1, wherein the first processing is rateless coding, and wherein performing the first processing on the N layers of first bit sequences comprises:
performing, by the transmit end, rateless coding on layer-n first bit sequences in the N layers of first bit sequences, to obtain layer-n third bit sequences, wherein n=1, 2, . . . , N.

5. (canceled)

6. The method according to claim 3, wherein the second processing comprises bit splicing and constellation modulation, and wherein performing the second processing on the first information comprises:
performing, by the transmit end, bit splicing on N layers of third bit sequences, to obtain one layer of fourth bit sequences; and
performing, by the transmit end, constellation modulation on the fourth bit sequences, to obtain the second information.

7. (canceled)

8. The method according to claim 3, wherein the second processing comprises bit splicing, constellation modulation, and constellation symbol splicing, and wherein performing the second processing on the first information comprises:
performing, by the transmit end, bit splicing on N layers of third bit sequences, to obtain M layers of fourth bit sequences, wherein a layer-m fourth bit sequence in the M layers of fourth bit sequences comprises the m^{th} bit in all third bit sequences that are in the N layers of third bit sequences and that comprise the m^{th} bit, M is an integer greater than 1, and m is an integer greater than 0 and less than or equal to M;
separately performing, by the transmit end, constellation modulation on the M layers of fourth bit sequences, to obtain M layers of constellation symbol sequences; and
performing, by the transmit end, constellation symbol splicing on the M layers of constellation symbol sequences, to obtain the second information.

9. (canceled)

10. The method according to claim 3, wherein the second processing comprises constellation modulation and constellation symbol splicing, and wherein performing the second processing on the first information comprises:
separately performing, by the transmit end, constellation modulation on N layers of third bit sequences, to obtain N layers of constellation symbol sequences; and
performing, by the transmit end, constellation symbol splicing on the N layers of constellation symbol sequences, to obtain the second information.

11-12. (canceled)

13. A data processing method, comprising:
receiving, by a receive end, second information and third information from a transmit end, wherein the second information is obtained by performing second processing on first information by the transmit end, the first information is obtained by performing first processing on N layers of first bit sequences by the transmit end, the N layers of first bit sequences are obtained by layering original information by the transmit end, the original information is at least one bit sequence or at least one integer, the third information is obtained by performing channel coding and constellation modulation on coding information of the N layers of first bit sequences by the transmit end, the coding information indicates proportion information of 0 or 1 in each of the N layers of first bit sequences, and N is an integer greater than 1;
performing, by the receive end, constellation demodulation and channel decoding on the third information, to obtain the coding information;
performing, by the receive end, third processing on the second information, to obtain first soft information, wherein the first soft information is a log-likelihood ratio corresponding to each bit in the first information;
performing, by the receive end, fourth processing on the first soft information based on the coding information, to obtain second soft information, wherein the second soft information is a log-likelihood ratio corresponding to a bit in each of the N layers of first bit sequences; and
reconstructing, by the receive end, the second soft information, to obtain the original information.

14. The method according to claim 13, wherein the third processing comprises constellation demodulation and soft information splitting, and wherein performing the third processing on the second information comprises:
performing, by the receive end, constellation demodulation on the second information, to obtain third soft information, wherein the third soft information is a log-likelihood ratio corresponding to each bit in a fourth bit sequence, the fourth bit sequence is obtained by performing bit splicing on N layers of third bit sequences by the transmit end, and the N layers of third bit sequences are the first information; and
performing, by the receive end, soft information splitting on the third soft information, to obtain the first soft information, wherein the first soft information comprises N layers of soft information, and one layer of soft information is a log-likelihood ratio corresponding to a bit in one of the N layers of third bit sequences.

15. The method according to claim 13, wherein the third processing comprises constellation symbol splitting, constellation demodulation, and soft information splitting, and wherein performing, by the receive end, third processing on the second information comprises:
performing, by the receive end, constellation symbol splitting on the second information, to obtain M layers of constellation symbol sequences, wherein the M layers of constellation symbol sequences are obtained by performing constellation modulation on M layers of fourth bit sequences by the transmit end, the M layers of fourth bit sequences are obtained by performing bit splicing on N layers of third bit sequences by the transmit end, a layer-m fourth bit sequence in the M layers of fourth bit sequences comprises the m^{th} bit in all third bit sequences that are in the N layers of third bit sequences and that comprise the m^{th} bit, the N layers of third bit sequences are the first information, M is an integer greater than 1, and m is an integer greater than 0 and less than or equal to M;
separately performing, by the receive end, constellation demodulation on the M layers of constellation symbol sequences, to obtain M layers of third soft information, wherein the M layers of third soft information each are a log-likelihood ratio corresponding to a bit in the M layers of fourth bit sequences; and
performing, by the receive end, soft information splitting on the M layers of third soft information, to obtain the first soft information, wherein the first soft information comprises N layers of soft information, and one layer of soft information is a log-likelihood ratio corresponding to a bit in one of the N layers of third bit sequences.

16. The method according to claim 13, wherein the third processing comprises constellation symbol splitting and constellation demodulation, and wherein performing the third processing on the second information comprises:
performing, by the receive end, constellation symbol splitting on the second information, to obtain N layers of constellation symbol sequences, wherein the N layers of constellation symbol sequences are obtained by separately performing constellation modulation on N layers of third bit sequences by the transmit end, and the N layers of third bit sequences are the first information; and
separately performing, by the receive end, constellation demodulation on the N layers of constellation symbol sequences, to obtain the first soft information, wherein the first soft information comprises N layers of soft information, and one layer of soft information is a log-likelihood ratio corresponding to a bit in one of the N layers of third bit sequences.

17. The method according to claim 14, wherein the fourth processing comprises soft information splicing and channel decoding, and wherein performing the fourth processing on the first soft information comprises:
performing, by the receive end, soft information calculation based on the coding information, to obtain a log-likelihood ratio sequentially corresponding to a bit that is in a layer-n first bit sequence in the N layers of first bit sequences and that is clipped in a bit clipping process, wherein n=1, 2, . . . , N;
performing, by the receive end, soft information splicing on the log-likelihood ratio sequentially corresponding to the bit that is in the layer-n first bit sequence and that is clipped in the bit clipping process and a log-likelihood ratio in the n^{th} layer of soft information in the first soft information, to obtain a soft information sequence corresponding to a layer-n second bit sequence, wherein the soft information sequence corresponding to the layer-n second bit sequence comprises a log-likelihood ratio sequentially corresponding to a bit in the layer-n second bit sequence, the log-likelihood ratio in the nth layer of soft information is a log-likelihood ratio corresponding to a bit in a layer-n third bit sequence in the N layers of third bit sequences, the layer-n third bit sequence is obtained by performing bit clipping on the layer-n second bit sequence by the transmit end, and the layer-n second bit sequence is obtained by performing channel coding on the layer-n first bit sequence in the N layers of first bit sequences by the transmit end; and
performing, by the receive end, channel decoding on a soft information sequence corresponding to each of N layers of second bit sequences, to obtain the second soft information, wherein the second soft information comprises a log-likelihood ratio corresponding to a bit in each of the N layers of first bit sequences.

18. The method according to claim 14, wherein the fourth processing is rateless decoding, and wherein performing the fourth processing on the first soft information comprises:
performing, by the receive end, soft information calculation based on the coding information, to obtain a log-likelihood ratio sequentially corresponding to a bit in a layer-n first bit sequence in the N layers of first bit sequences, wherein n=1, 2, . . . , N; and
performing, by the receive end, rateless decoding on the first soft information based on the log-likelihood ratio that sequentially corresponds to the bit in each of the N layers of first bit sequences and that is obtained through soft information calculation, to obtain the second soft information, wherein the second soft information comprises the log-likelihood ratio corresponding to the bit in each of the N layers of first bit sequences.

19-28. (canceled)

29. A transmit end apparatus, comprising:
a processor; and
a transceiver;
wherein the processor and the transceiver are configured to communicate with each other through an internal connection; and
wherein the processor is configured to:
layer original information, to obtain N layers of first bit sequences, wherein the original information is at least one bit sequence or at least one integer, and N is an integer greater than 1;
perform first processing on the N layers of first bit sequences, to obtain first information;
perform second processing on the first information, to obtain second information; and
perform channel coding and constellation modulation on coding information of the N layers of first bit sequences, to obtain third information, wherein the coding information indicates proportion information of 0 or 1 in each of the N layers of first bit sequences; and
wherein the transceiver is configured to send the second information and the third information to a receive end.

30. The transmit end apparatus according to claim 29, wherein layering the original information comprises:
layering the original information in descending order or ascending order of importance of information in the original information, to obtain the N layers of first bit sequences.
